(19) United States
(12) Patent Application Publication
(10) Pub. No.: US 2011/0061154 A1
(43) Pub. Date: Mar. 17, 2011

(54) Cushioning Elements For Apparel And Other Products

(75) Inventors: David Turner, Portland, OR (US); Tiffany A. Beers, Portland, OR (US)

(73) Assignee: NIKE, INC., Beaverton, OR (US)

(21) Appl. No.: 12/720,070

(22) Filed: Mar. 9, 2010

Related U.S. Application Data
(60) Provisional application No. 61/158,653, filed on Mar. 9, 2009.

(51) Int. Cl. A41D 13/015; B32B 3/10; B32B 3/00; B32B 3/28; B32B 1/06; B32B 3/26

(52) U.S. Cl. 2/455; 428/138; 428/172; 428/76; 428/159

(57) ABSTRACT

Cushioning elements may include a first material layer, a second material layer, a plurality of components (e.g., polymer foam components) that are located between the first material layer and the second material layer. Some of the components are secured to the first material layer and the second material layer, and other components are unsecured to the first material layer and the second material layer. In some configurations, the various components have different thicknesses. In further configurations, at least one of the component defines a plurality of apertures that receive other components.

### CROSS-REFERENCE TO RELATED APPLICATION

This non-provisional U.S. patent application claims priority under 35 U.S.C. §119(e)(1) to provisional U.S. Patent Application Ser. No. 61/158,653, which was filed in the U.S. Patent and Trademark Office on 9 Mar. 2009 and entitled Cushioning Elements For Apparel And Other Products, such provisional U.S. patent application being entirely incorporated herein by reference.

### BACKGROUND

Materials or elements that impart padding, cushioning, or otherwise attenuate impact forces are commonly incorporated into a variety of products. Athletic apparel, for example, often incorporates cushioning elements that protect the wearer from contact with other athletes, equipment, or the ground. More specifically, pads used in American football and hockey incorporate cushioning elements that provide impact protection to various parts of a wearer. Helmets utilized during American football, hockey, bicycling, skiing, snowboarding, and skateboarding incorporate cushioning elements that provide head protection during falls or crashes. Similarly, gloves utilized in soccer (e.g., by goalies) and hockey incorporate cushioning elements that provide protection to the hands of a wearer. In addition to apparel, mats (e.g., for yoga or camping), chair cushions, and backpacks all incorporate cushioning elements to enhance comfort.

### SUMMARY

Various cushioning elements that may be utilized in apparel and a variety of other products are disclosed below. In general, the cushioning elements include a first material layer, a second material layer, a plurality of pad components, and a frame component. The pad components are located between and secured to the first material layer and the second material layer. The frame component is also located between the first material layer and the second material layer, but is unsecured to the first material layer, the second material layer, and the pad components. In some configurations, various pad components have different thicknesses. In further configurations, the frame component defines a plurality of apertures that receive at least a portion of the pad components. In other configurations, some pad components may have different colors, with the pad components being visible through at least one of the first material layer and the second material layer.

Articles of apparel are also disclosed below, including shorts, pants, shirts, wraps, gloves, helmets, and footwear, for example. In general, the articles of apparel include, a first material layer, a second material layer, and a plurality of foam components located between the first material layer and the second material layer. At least one of the foam components is secured to both of the first material layer and the second material layer, and at least one of the foam components is unsecured to both of the first material layer and the second material layer. Additionally, the foam components have corresponding shapes that mate with each other to form a foam layer within the apparel.

In another configuration, a cushioning element may include a first material layer, a second material layer, a plurality of first strips, and a plurality of second strips. The first strips are located between and secured to the first material layer and the second material layer, and the first strips are spaced from each other. The second strips are also located between the first material layer and the second material layer, and the second strips may be unsecured to the first material layer and the second material layer. Also, the second strips are positioned between the first strips.

The advantages and features of novelty characterizing aspects of the invention are pointed out with particularity in the appended claims. To gain an improved understanding of the advantages and features of novelty, however, reference may be made to the following descriptive matter and accompanying figures that describe and illustrate various configurations and concepts related to the invention.

### FIGURE DESCRIPTIONS

The foregoing Summary and the following Detailed Description will be better understood when read in conjunction with the accompanying figures.

FIG. 1 is a front elevational view of an individual wearing an article of apparel.

FIG. 2 is a front elevational view of the article of apparel.

FIGS. 3 and 4 are side elevational views of the article of apparel.

FIG. 5 is a rear elevational view of the article of apparel.

FIG. 6 is a perspective view of a cushioning element.

FIG. 7 is an exploded perspective view of the cushioning element.

FIG. 8 is a top plan view of the cushioning element.

FIGS. 9A and 9B are cross-sectional views of the cushioning element, as defined by section lines 9A and 9B in FIG. 8.

FIGS. 10A-10C are cross-sectional views corresponding with FIG. 9A and depicting the cushioning element in compressed states.

FIGS. 11A-11F are schematic perspective views of a manufacturing process for the cushioning element.

FIGS. 12A-12E are schematic cross-sectional views of the manufacturing process, as respectively defined by section lines 12A-12E in FIGS. 11A-11E.

FIGS. 13A-13E are exploded perspective views corresponding with FIG. 7 and depicting further configurations of the cushioning element.

FIGS. 14A-14P are top plan views corresponding with FIG. 8 and depicting further configurations of the cushioning element.

FIGS. 15A-15H are cross-sectional views corresponding with FIG. 9A and depicting further configurations of the cushioning element.

FIGS. 16A-16H are elevational views of articles of apparel incorporating the cushioning element.

FIGS. 17A-17C are perspective views of further products incorporating the cushioning element.

FIG. 18 is a perspective view of another configuration of the cushioning element.

FIG. 19 is an exploded perspective view of the cushioning element depicted in FIG. 18.

FIG. 20 is a side elevational view of an article of footwear incorporating the cushioning element depicted in FIG. 18.

### DETAILED DESCRIPTION

The following discussion and accompanying figures disclose various cushioning elements that may be incorporated into a variety of products, including articles of apparel (e.g., shorts, pants, shirts, wraps, gloves, helmets, and footwear), mats, seat cushions, and backpacks, for example. Additionally, the following discussion and accompanying figures disclose various processes for manufacturing the cushioning elements.

Apparel Configuration

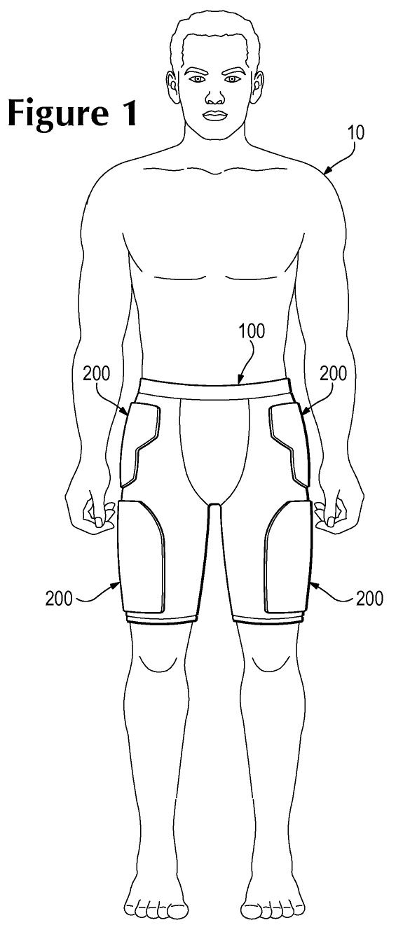

With reference to FIG. 1, an individual 10 is depicted as wearing an article of apparel 100 with the general configuration of a shorts-type garment. Although apparel 100 may be worn under other articles of apparel, apparel 100 may be worn alone, may be exposed, or may be worn over other articles of apparel. Apparel 100 may also be worn in combination with other pieces of equipment (e.g., athletic or protective equipment). Accordingly, the configuration of apparel 100 and the manner in which apparel 100 is worn by individual 10 may vary significantly.

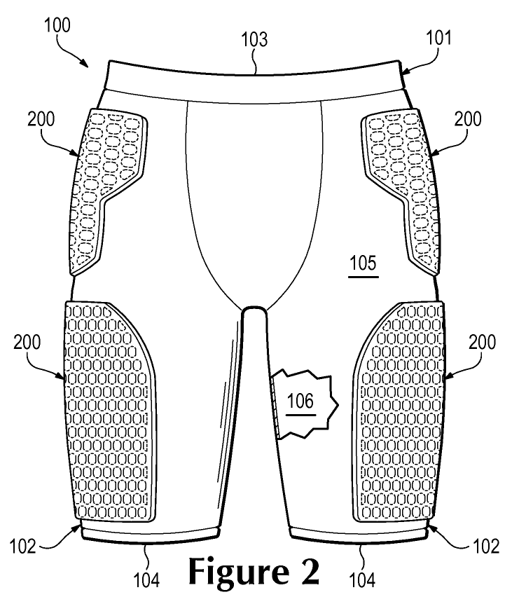

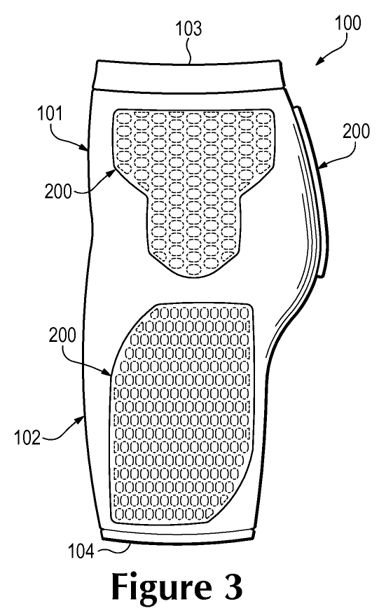

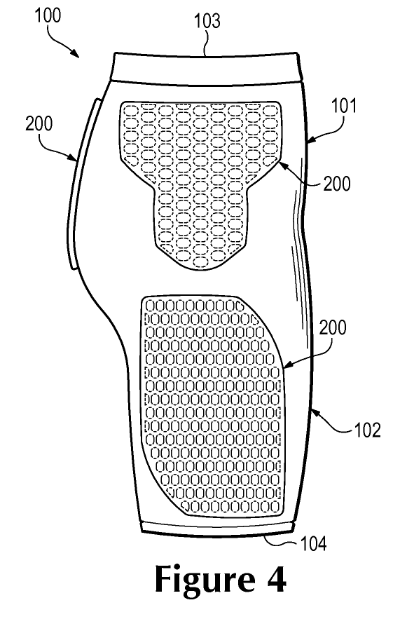

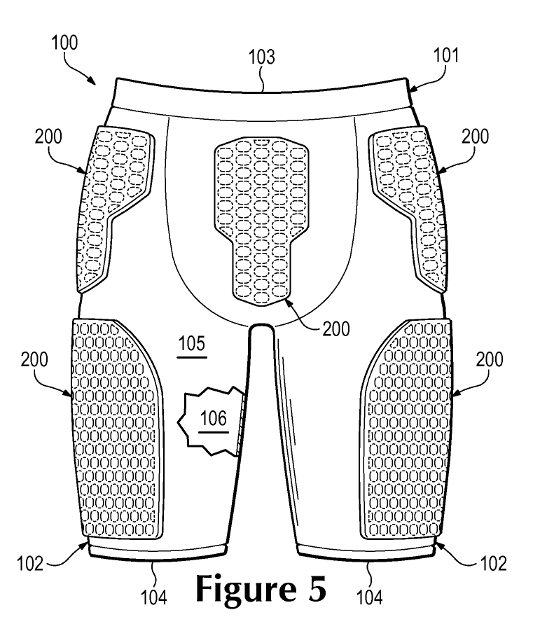

Apparel 100 is depicted individually in FIGS. 2-5 as including a pelvic region 101 and a pair of leg regions 102 that extend outward from pelvic region 101. Pelvic region 101 corresponds with a pelvic area of individual 10 and covers at least a portion of the pelvic area when worn. An upper area of pelvic region 101 defines a waist opening 103 that extends around a waist of individual 10 when apparel 100 is worn. Leg regions 102 correspond with a right leg and a left leg of individual 10 and cover at least a portion of the right leg and the left leg when worn. Lower areas of leg regions 102 each define a thigh opening 104 that extends around a thigh of individual 10 when apparel 100 is worn. Additionally, apparel 100 includes an exterior surface 105 that faces away from individual 10 when apparel 100 is worn, and apparel 100 includes an opposite interior surface 106 that faces toward individual 10 and may contact individual 10 when apparel 100 is worn.

A plurality of cushioning elements 200 are incorporated into various areas of apparel 100 to impart padding, cushioning, or otherwise attenuate impact forces. When apparel 100 is worn during athletic activities, for example, cushioning elements 200 may protect individual 10 from contact with other athletes, equipment, or the ground. With regard to apparel 100, cushioning elements 200 are located in both of pelvic region 101 and leg regions 102 and are positioned, more specifically, to protect the hips, thighs, and tailbone of individual 10. As described in greater detail below, a variety of different articles of apparel may incorporate cushioning elements 200, and cushioning elements 200 may be positioned in various areas of the apparel to protect specific portions (e.g., muscles, bones, joints, impact areas) of individual 10. Additionally, the shapes, sizes, and other properties of cushioning elements 200, as well as the materials utilized in cushioning elements 200, may vary significantly to provide a particular level of protection to the specific portions of individual 10.

Cushioning Element Configuration

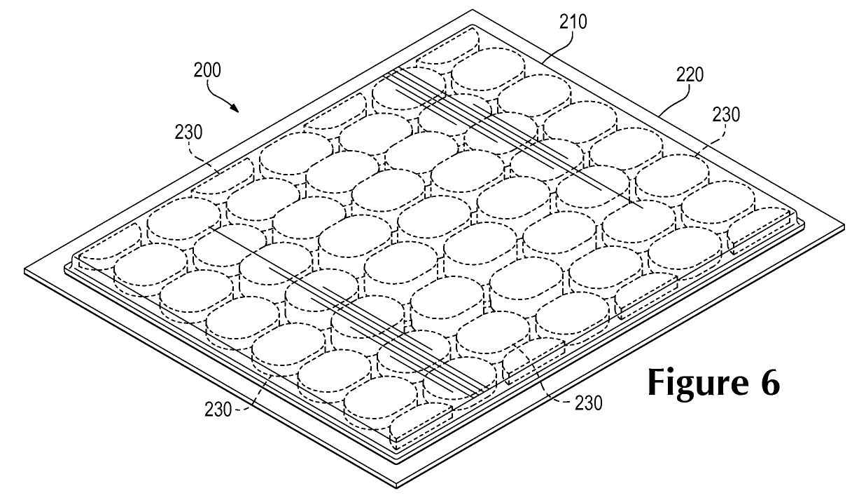

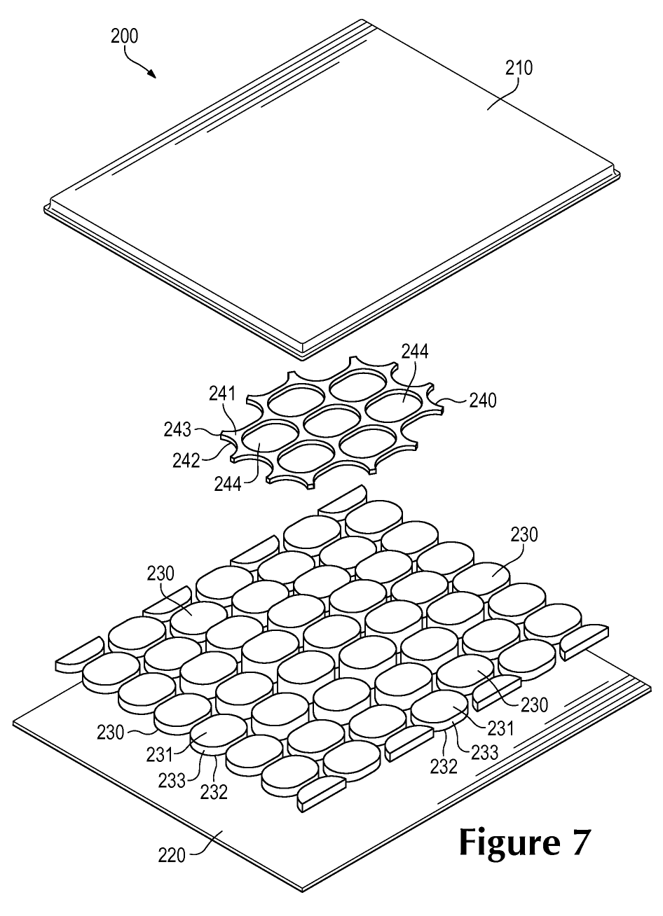

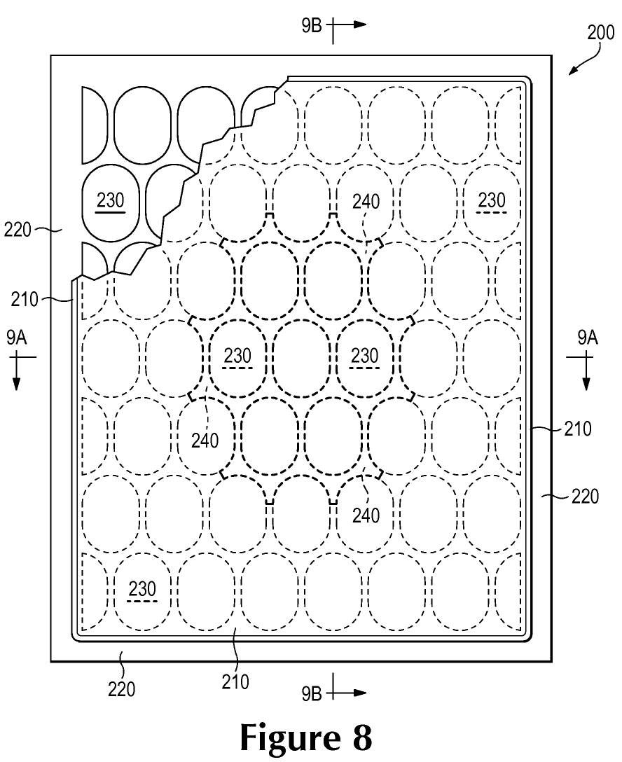

An example configuration for cushioning element 200 is depicted in FIGS. 6-9B as including a first material layer 210, a second material layer 220, a plurality of pad components 230, and a frame component 240. In general, pad components 230 and frame component 240 are positioned between first material layer 210 and second material layer 220. Although pad components 230 are secured to first material layer 210 and second material layer 220, frame component 240 is unsecured to each of first material layer 210, second material layer 220, and pad components 230.

First material layer 210 and second material layer 220 cooperatively form an outer surface or covering for cushioning element 200. That is, first material layer 210 and second material layer 220 cooperatively form a pocket or void, in which pad components 230 and frame component 240 are located. Whereas second material layer 220 is depicted as having a generally planar configuration, first material layer 210 extends over pad components 230 and frame component 240 and also along sides of pad components 230 to join with second material layer 220 (e.g., through stitching, an adhesive, or thermal bonding). Although cushioning element 200 may be incorporated into apparel 100 in a variety of ways, first material layer 210 may be positioned exterior of second material element 220. That is, first material layer 210 may form a portion of exterior surface 105, whereas second material layer 220 may form a portion of interior surface 106. An advantage to this configuration is that cushioning element 200 protrudes outward from apparel 100, rather than protruding inward and toward individual 10. In some configurations of apparel 100, however, cushioning element 200 may protrude inward.

A variety of materials may be utilized for first material layer 210 and second material layer 220, including various textiles, polymer sheets, leather, or synthetic leather, for example. Combinations of these materials (e.g., a polymer sheet bonded to a textile) may also be utilized for material layers 210 and 220. Although material layers 210 and 220 may be formed from the same material, each of material layers 210 and 220 may also be formed from different materials. With regard to textiles, material layers 210 and 220 may be formed from knitted, woven, or non-woven textile elements that include rayon, nylon, polyester, polyacrylic, cotton, wool, or silk, for example. Moreover, the textiles may be non-stretch, may exhibit one-directional stretch, or may exhibit multi-directional stretch. Accordingly, a variety of materials are suitable for first material layer 210 and second material layer 220.

Pad components 230 are located between and secured to each of material layers 210 and 220. Each of pad components 230 has a first surface 231 secured to first material layer 210, an opposite second surface 232 secured to second material layer 220, and a side surface 233 that extends between surfaces 231 and 232. Although the shapes of pad components 230 may vary significantly, each of surfaces 231 and 232 are depicted as having an elliptical or generally elongate shape with rounded end areas, and side surface 233 extends in a generally straight fashion between surfaces 231 and 232. Pad components 230 are spaced evenly from each other and arranged in offset rows. Given that cushioning element 200 is depicted as having a generally rectangular configuration, various pad components 230 around a perimeter of cushioning element 200 exhibit a truncated or partial configuration.

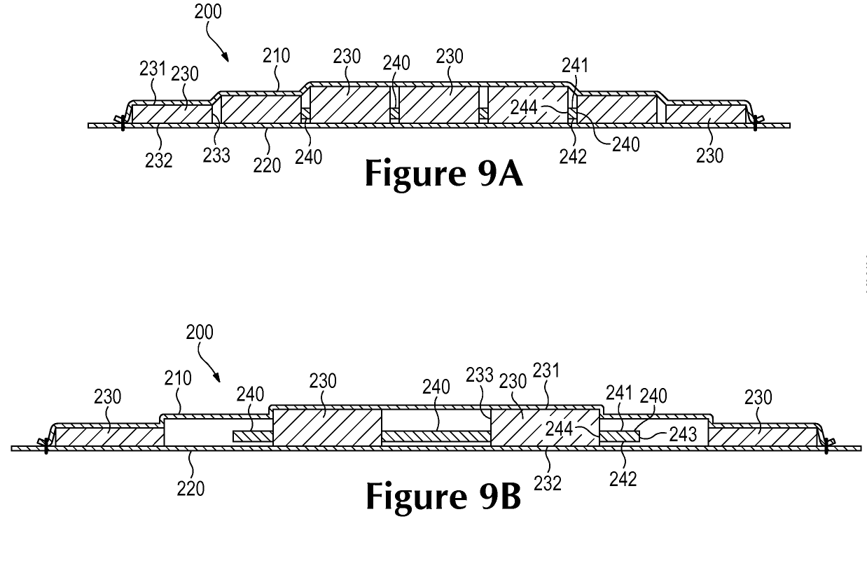

Although many of pad components 230 may exhibit similar shapes, the thicknesses of pad components 230 may vary significantly. As utilized in the present document, the term “thickness” or variants thereof is intended to refer to a distance that is generally perpendicular to portions material layers 210 and 220 that are secured to surfaces 231 and 232 of pad components 230. As such, the thickness of pad components 230 is generally defined as the distance between surfaces 231 and 232. Referring to the cross-sectional views of FIGS. 9A and 9B, for example, the various pad components 230 across a width of cushioning element 200 are depicted as having a range of three different thicknesses. More particularly, a group of pad components 230 located in a central area of cushioning element 200 exhibit a maximum thickness, a group of pad components 230 located around the central area exhibit a medium thickness, and a group of pad components 230 located adjacent to a periphery of cushioning element 200 exhibit a minimum thickness. In general, therefore, the thicknesses of pad components 230 may decrease depending upon their relative proximity to the periphery of cushioning element 200.

Pad components 230 exhibiting the maximum thickness are depicted as being located in the central area of cushioning element 200. In further configurations, these pad components 230 may extend to the periphery of cushioning element 200 or may be entirely located at the periphery. Even when pad components 230 exhibiting the maximum thickness extend to the periphery, pad components 230 with a lesser thickness may extend at least partially around the pad components 230 with the maximum thickness to form areas or groups of pad components 230 with a common thickness in cushioning element 200.

An advantage of forming pad components 230 to have varying thicknesses relates to the comfort of apparel 100 and the integration of apparel 100 with other articles of apparel or equipment. The lesser thickness of pad components 230 located adjacent to a periphery of cushioning element 200 imparts a lower profile to cushioning element 200 at the periphery. Given the lower profile, portions of cushioning element 200 at the periphery may be less noticeable to individual 10 and may interfere less with the other articles of apparel or equipment. The thicknesses of pad components 230 may vary significantly. As examples, the various groups of pad components 230 may have thicknesses of approximately (a) 12 millimeters, 9 millimeters, and 6 millimeters; (b) 12 millimeters, 6 millimeters, and 3 millimeters; (c) 10 millimeters, 7 millimeters, and 4 millimeters; (d) 7 millimeters, 5 millimeters, and 3 millimeters; or (e) 5 millimeters, 3 millimeters, and 1 millimeter. More generally, the various thicknesses of pad components may range from 1 to 20 millimeters or more.

A variety of materials may be utilized for pad components 230, including various polymer foam materials that return to an original shape after being compressed. Examples of suitable polymer foam materials for pad components 230 include polyurethane, ethylvinylacetate, polyester, polypropylene, and polyethylene foams. Moreover, both thermoplastic and thermoset polymer foam materials may be utilized. In some configurations of cushioning element 200, pad components 230 may be formed from a polymer foam material with a varying density, or solid polymer or rubber materials may be utilized. Also, different pad components 230 may be formed from different materials, or may be formed from similar materials with different densities. As discussed above, the thicknesses of pad components 230 may vary significantly. In some configurations, pad components 230 with the maximum thickness may be formed from a polymer foam material with a different density than pad components with a lesser thickness. Alternately, pad components 230 with different thicknesses may all be formed from polymer foam materials with the same densities, or pad components 230 with different thicknesses may all be formed from different materials. As discussed in greater detail below, the polymer foam materials forming pad components 230 attenuate impact forces to provide cushioning or protection. By selecting thicknesses, materials, and densities for each of the various pad components 230, the degree of impact force attenuation may be varied throughout cushioning component 200 to impart a desired degree of cushioning or protection.

Frame component 240 is located between each of material layers 210 and 220. In contrast with pad components 230, frame component 240 is unsecured to each of first material layer 210 and second material layer 220, and frame component 240 is also unsecured to pad components 230. This configuration permits frame component 240 to float or otherwise move relative to first material layer 210, second material layer 220, and pad components 230. Frame component 240 has a first surface 241, an opposite second surface 242, and a side surface 243 extending between surfaces 241 and 242. Additionally, frame component 240 defines a plurality of apertures 244 having the general shape of pad components 230. Given this configuration, frame component 240 extends around and between various pad components 230. In areas where frame component 240 is present, the combination of pad components 230 and frame component 240 effectively forms a foam layer within cushioning element 200. Although the dimensions of apertures 244 may substantially match the dimensions of pad components 230, frame component 240 may also be formed such that a gap extends between edges of apertures 244 and side surfaces 233 of pad components 230.

Frame component 240 is depicted as being located in the central area of cushioning element 200 and extending around only the pad components 230 that exhibit the maximum thickness. As an alternative, frame component 240 may extend (a) throughout cushioning element 200 and define apertures 244 that extend around all of pad components 230, (b) around the pad components 230 that exhibit the medium thickness, or (c) around only some of the pad components having the maximum, medium, and minimum thicknesses. Additionally, frame component 240 may extend to the periphery of cushioning element 200 in some areas, but not in other areas. Accordingly, the portions of cushioning element 200 into which frame component 240 extends may vary significantly.

Referring to the cross-sectional views of FIGS. 9A and 9B, for example, frame component 240 is depicted as exhibiting lesser thickness (i.e., distance between surfaces 241 and 242) than each of pad components 230. An advantage of this configuration is that frame component 240 may move relative to material layers 210 and 220, thereby enhancing the flexibility of cushioning element 200. As an example, frame component 240 may have a thickness of approximately 2 millimeters in a configuration wherein the pad components 230 with the minimum thickness are 3 millimeters. In other configurations, the thickness of frame component 240 may range from 1 to 20 millimeters or more. Although frame component 240 may exhibit lesser thickness than each of pad components 230, frame component 240 may also be thicker than some or all of pad components 230.

Any of the variety of materials discussed above as being suitable for pad components 230 may also be utilized for frame component 240, including various polymer foam materials that return to an original shape after being compressed. Examples of suitable polymer foam materials for frame component 240 include polyurethane, ethylvinylacetate, polyester, polypropylene, and polyethylene foams. Moreover, both thermoplastic and thermoset polymer foam materials may be utilized. In some configurations of cushioning element 200, frame component 240 may be formed from solid polymer or rubber materials.

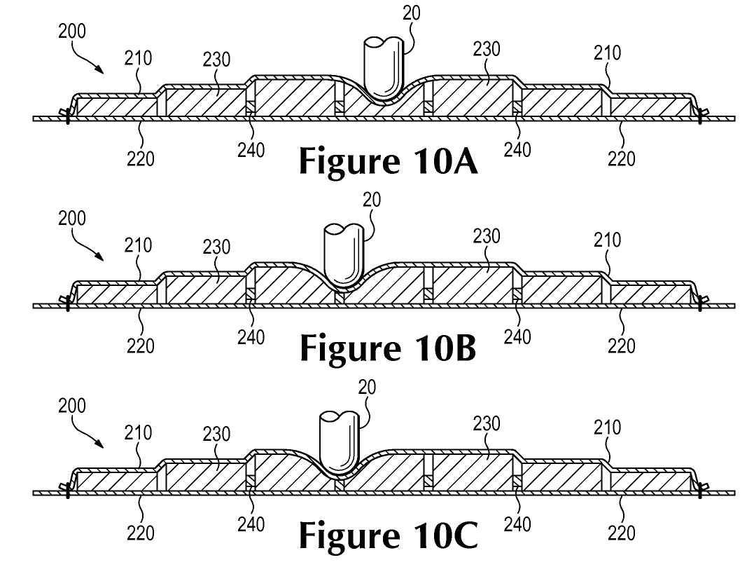

The compressible polymer foam materials forming pad components 230 and frame component 240 attenuate impact forces that compress or otherwise contact cushioning element 200. When incorporated into apparel 100 or another article of apparel, for example, the polymer foam materials of pad components 230 and frame component 240 may compress to protect a wearer from contact with other athletes, equipment, or the ground. Accordingly, cushioning element 200 may be utilized to provide cushioning or protection to areas of a wearer that are covered by cushioning element 200. Referring to FIGS. 10A-10C, an object 20 is depicted as impacting various portions of cushioning element 200. Given the configuration of cushioning element 200, particularly with regard to the combination of pad components 230 and frame component 240, object 20 may not generally project through cushioning element 200 regardless of the area of contact with cushioning element 200. More particularly, when object 20 contacts a portion of cushioning element 200 corresponding with one of pad components 230, as depicted in FIG. 10A, the pad component 230 compresses to attenuate impact forces and provide cushioning or protection. When object 20 contacts a portion of cushioning element 200 corresponding with an edge of one of pad components 230, as depicted in FIG. 10B, the pad component 230 and frame component 240 cooperatively compresses to attenuate impact forces and provide cushioning or protection. Similarly, when object 20 contacts a portion of cushioning element 200 corresponding with frame component 240 (i.e., at a location between two pad components 230), as depicted in FIG. 10C, frame component 240 compresses to attenuate impact forces and provide cushioning or protection. Accordingly, regardless of the area at which an object contacts cushioning element 200, either or both of pad components 230 and frame component 240 attenuates impact forces associated with the contact.

In addition to attenuating impact forces, cushioning element 200 has an advantage of simultaneously providing one or more of breathability, flexibility, a relatively low overall mass, and launderability. When incorporated into an article of apparel, particularly apparel used for athletic activities, a wearer may perspire and generate excess heat. By utilizing a permeable textile for material layers 210 and 220 and also forming gaps between adjacent pad components 230 and areas between pad components 230 and frame component 240, areas for air to enter the apparel and for moisture to exit the apparel are formed through cushioning component 200. More particularly, air and moisture may pass through material layers 210 and 220, between pad components 230 in areas where frame component 240 is absent, and between pad components 230 and frame component 240 in areas where frame component 240 is present to impart breathability to areas of the apparel having cushioning element 200. Moreover, the materials and structure discussed above for cushioning element 200 impart flexibility and a low overall mass to cushioning element 200. Furthermore, the materials and structure discussed above for cushioning element 200 permits cushioning element 200 to be laundered without significant shrinkage or warping, even when temperatures associated with commercial laundering processes are utilized. Accordingly, cushioning element 200 may simultaneously provide impact force attenuation, breathability, flexibility, a relatively low overall mass, and launderability to an article of apparel.

Manufacturing Processes

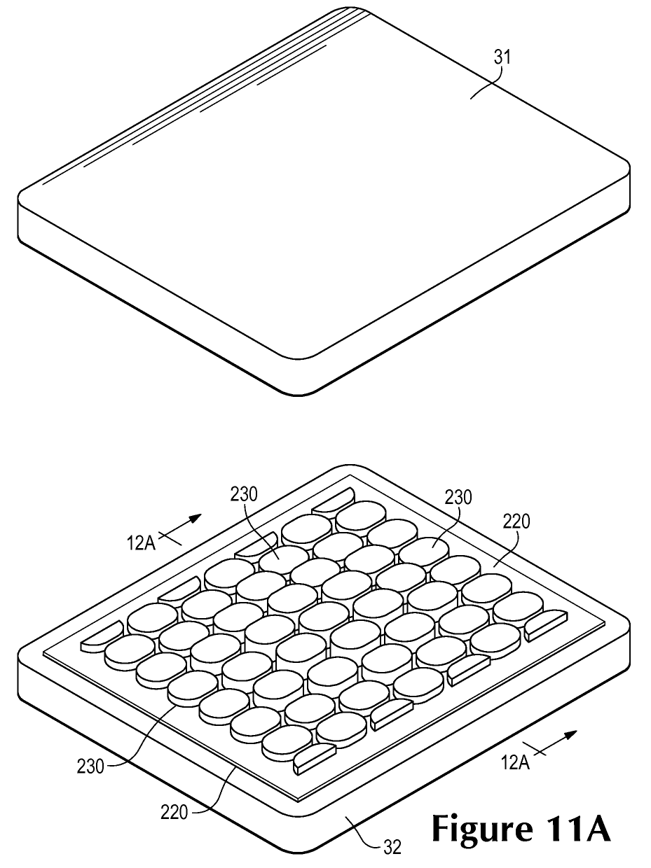

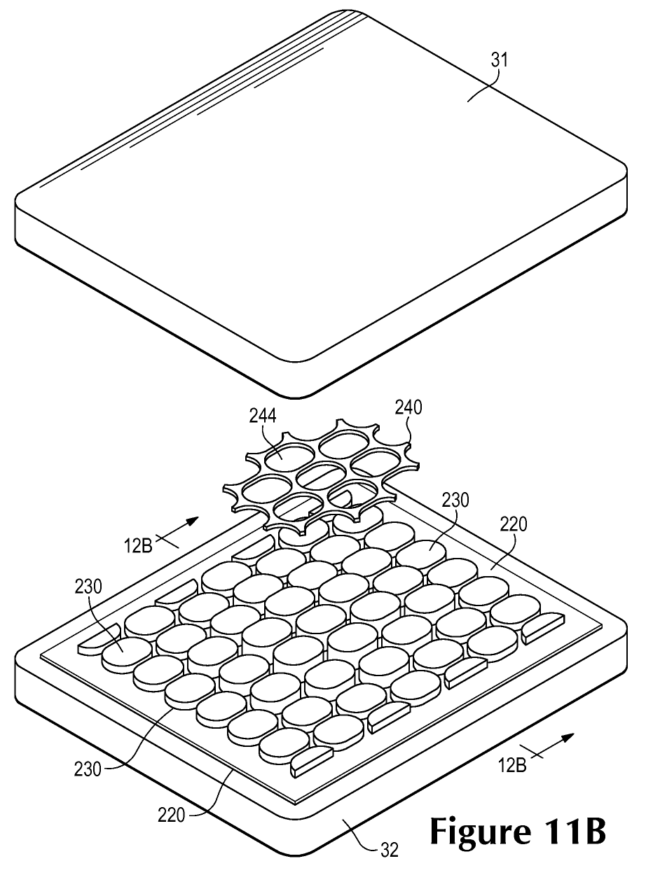

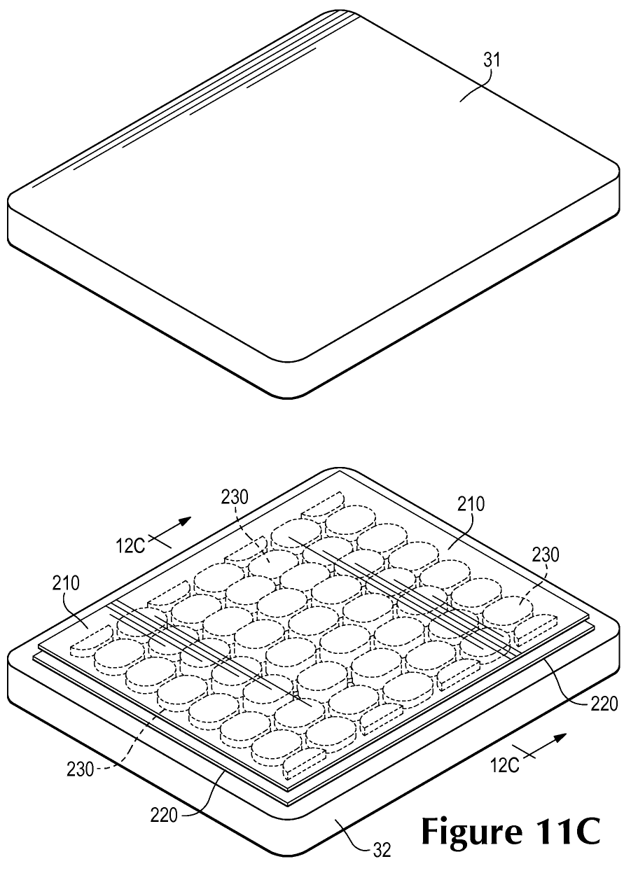

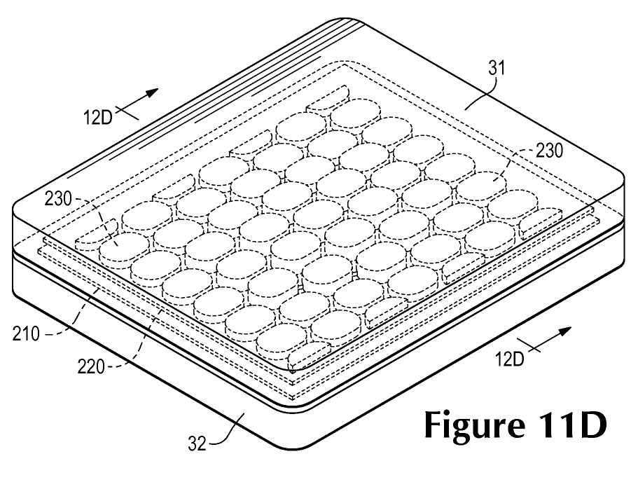

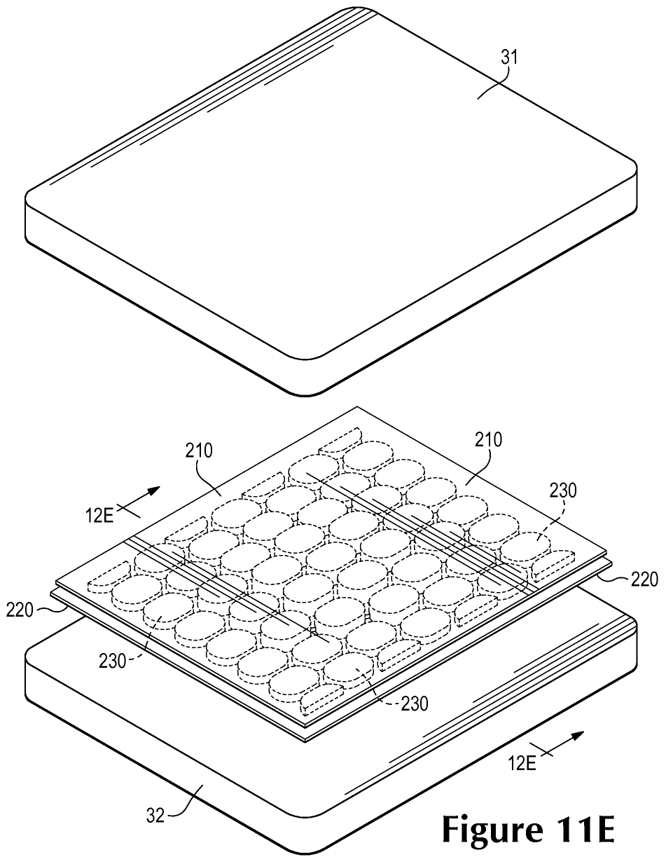

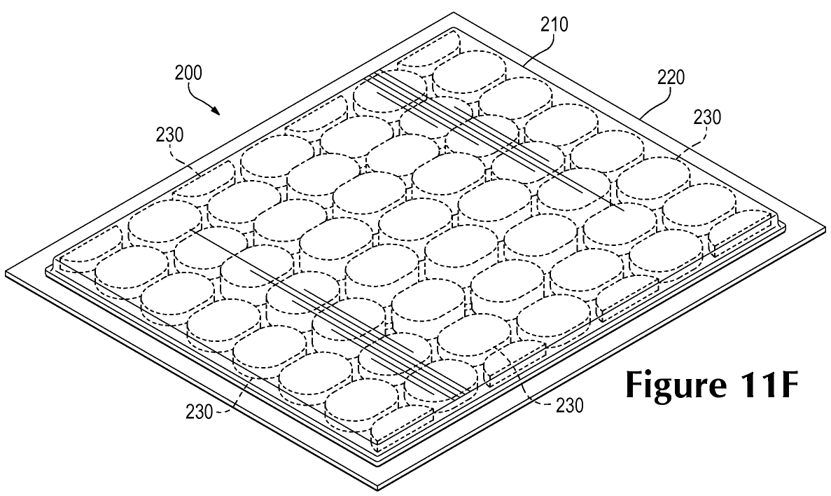

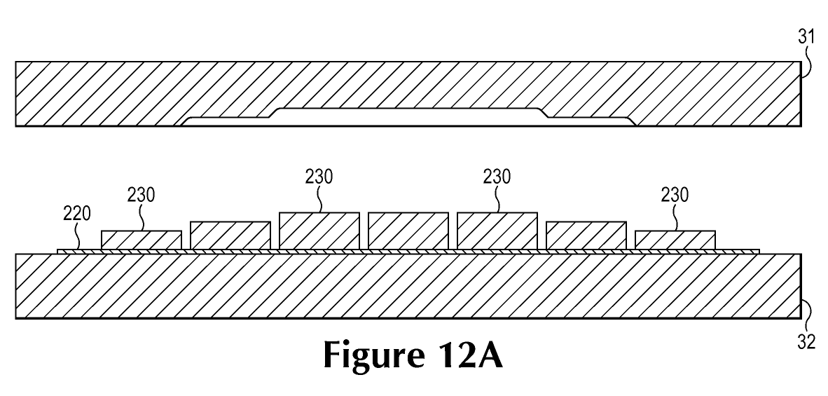

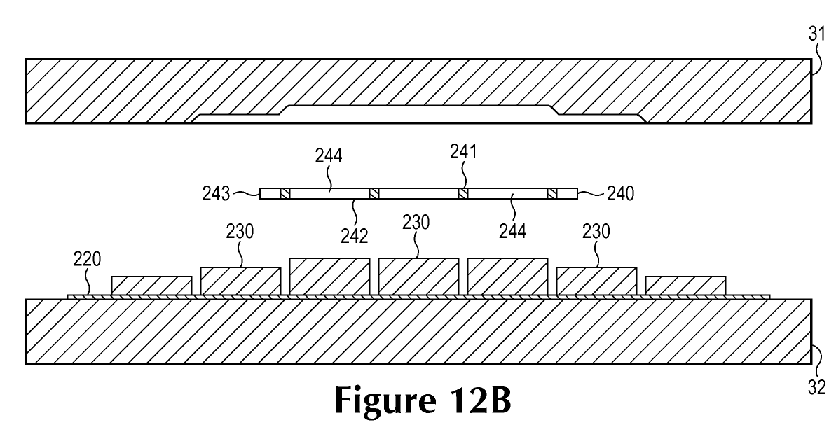

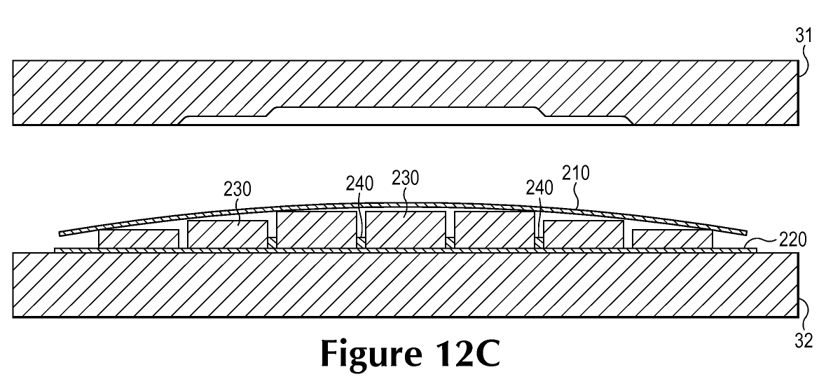

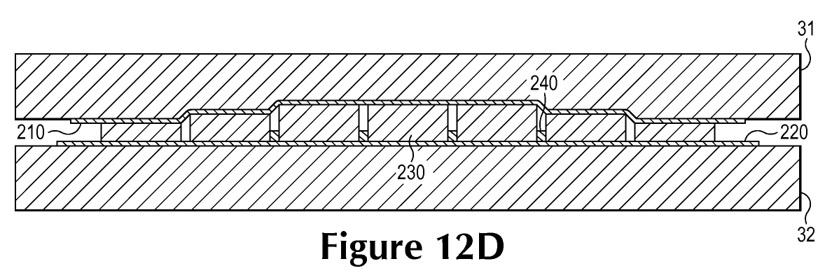

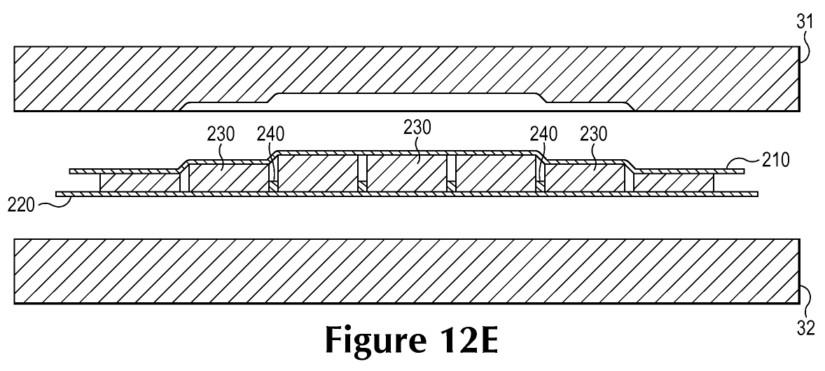

A variety of techniques may be utilized to manufacture cushioning element 200. With reference to FIGS. 11A-11F and 12A-12E, an example of a suitable manufacturing process is discussed. Initially, pad components 230 and frame component 240 are formed to have intended shapes and thicknesses through, for example, molding, die-cutting, or laser-cutting operations. Pad components 230 may also be extruded as a long element that is cut to desired thicknesses. Once pad components 230 and frame component 240 are formed, second material layer 220 and pad components 230 may be placed within a mold having a first mold portion 31 and a second mold portion 32, as depicted in FIGS. 11A and 12A. Frame component 240 is then located between mold portions 31 and 32, as depicted in FIGS. 11B and 12B. More particularly, frame component 240 is positioned such that apertures 244 align with selected pad components 230. First material layer 210 is then placed over pad components 230 and frame component 240, as depicted in FIGS. 11C and 12C, and frame component 240 is located between and around various pad components 230. That is, frame component 240 is positioned such that apertures 244 extend around selected pad components 230.

Whereas second mold portion 32 has a generally flat upper surface, first mold portion 31 has a stepped configuration. As discussed above, pad components 230 exhibit various thicknesses, and the stepped configuration of first mold portion 31 corresponds with the various thicknesses. Once material layers 210 and 220, pad components 230, and frame component 240 are properly positioned between mold portions 31 and 32, mold portions 31 and 32 may close upon and compress material layers 210 and 220, pad components 230, and frame component 240, as depicted in FIGS. 11D and 12D, to effect bonding between (a) first material layer 210 and first surfaces 231 of pad components 230 and (b) second material layer 220 and second surfaces 232 of pad components 230.

Mold portions 31 and 32 effectively compress pad components 230 between material layers 210 and 220 to ensure bonding. As an example, an adhesive may be utilized to bond pad components 230 to each of material layers 210 and 220. At prior stages of the manufacturing process, an adhesive may be applied to either (a) areas of material layers 210 and 220 that are intended to bond with pad components 230 or (b) surfaces 231 and 232 of pad components 230. Although the adhesive may be applied to material layers 210 and 220, an advantage of applying the adhesive to surfaces 231 and 232 of pad components 230 is that the adhesive is absent from areas of material layers 210 and 220 that may contact frame component 240. As another example, heat may be utilized to bond pad components 230 to each of material layers 210 and 220. In configurations where pad components 230 are formed from a thermoplastic polymer foam material, heating and melting of pad components 230 at surfaces 231 and 232 may be utilized to bond pad components 230 to each of material layers 210 and 220. Similarly, material layers 210 and 220 may also incorporate a thermoplastic polymer material. In order to elevate the temperatures, various radiant heaters, radio frequency emitters, or other devices may be utilized. Alternately, mold portions 31 and 32 may be heated such that contact with mold portions 31 and 32 raises the temperature of pad components 230 to a level that facilitates bonding. In some configurations, a thermally-activated adhesive may be utilized.

Following compression and bonding, mold portions 31 and 32 separate to expose material layers 210 and 220, pad components 230, and frame component 240, as depicted in FIGS. 11E and 12E. At this stage of the manufacturing process, first material layer 210 is unsecured to second material layer 220. Additional stitching, adhesive, or thermal bonding steps may now be utilized to join material layers 210 and 220 around the periphery of pad components 230, as depicted in FIG. 11F, thereby substantially completing the manufacture of cushioning element 200.

When incorporated into apparel, such as apparel 100, one of material layers 210 and 220 may be utilized to form other areas of the apparel. For example, second material layer 220 may form portions of apparel 100 that extend over the pelvic area or legs of individual 10. That is, second material layer 220 may extend outward from cushioning element 200 to form other portions of apparel 100. In these situations, second material layer 220 may have a shape and size that forms the other portions of apparel 100.

Further Cushioning Element Configurations

Aspects of cushioning element 200 may vary, depending upon the intended use for cushioning element 200 and the product in which cushioning element 200 is incorporated. Moreover, changes to the dimensions, shapes, and materials utilized within cushioning element 200 may vary the overall properties of cushioning element 200. That is, by changing the dimensions, shapes, and materials utilized within cushioning element 200, the compressibility, impact force attenuation, breathability, flexibility, and overall mass of cushioning element 200 may be tailored to specific purposes or products. A plurality of variations for cushioning element 200 are discussed below. Any of these variations, as well as combinations of these variations, may be utilized to tailor the properties of cushioning element 200 to an intended use or particular product.

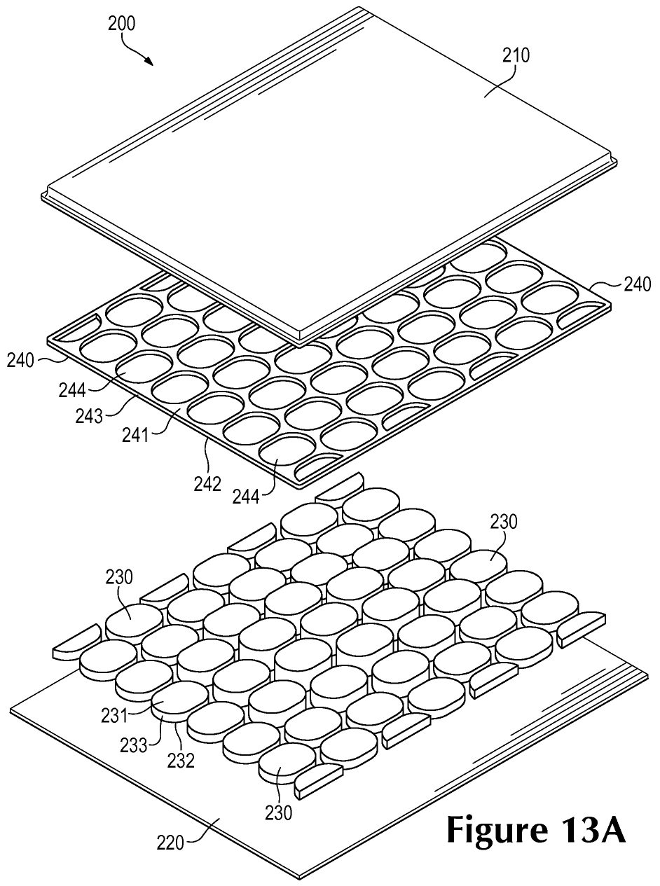

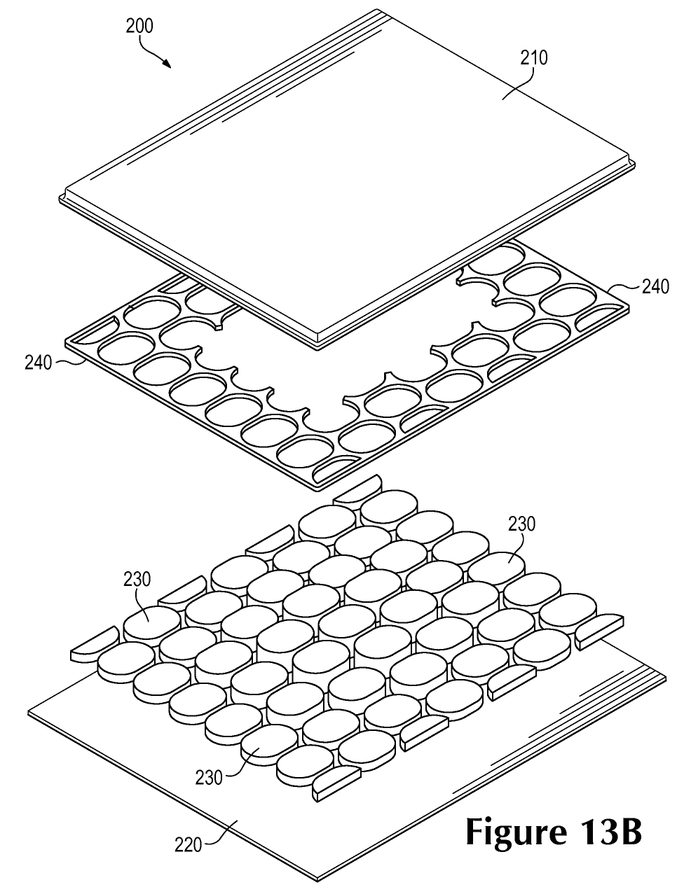

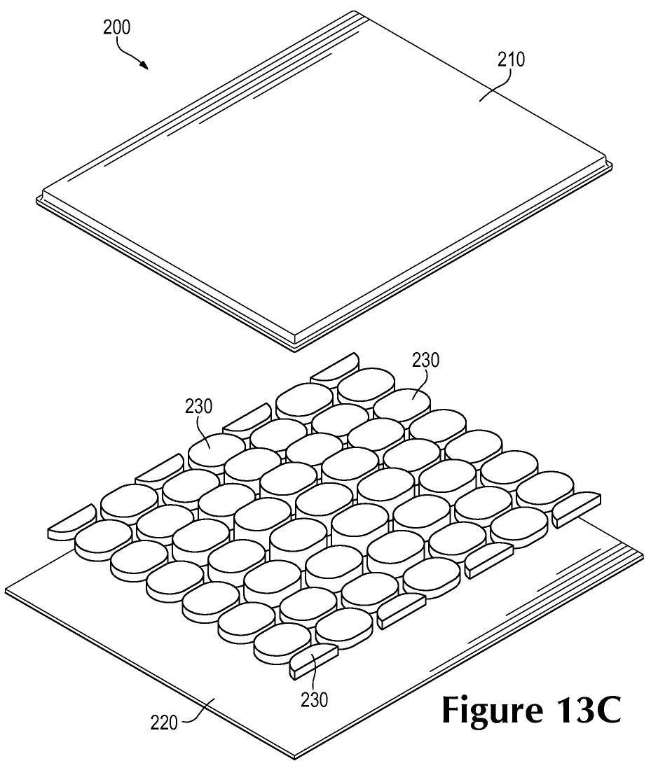

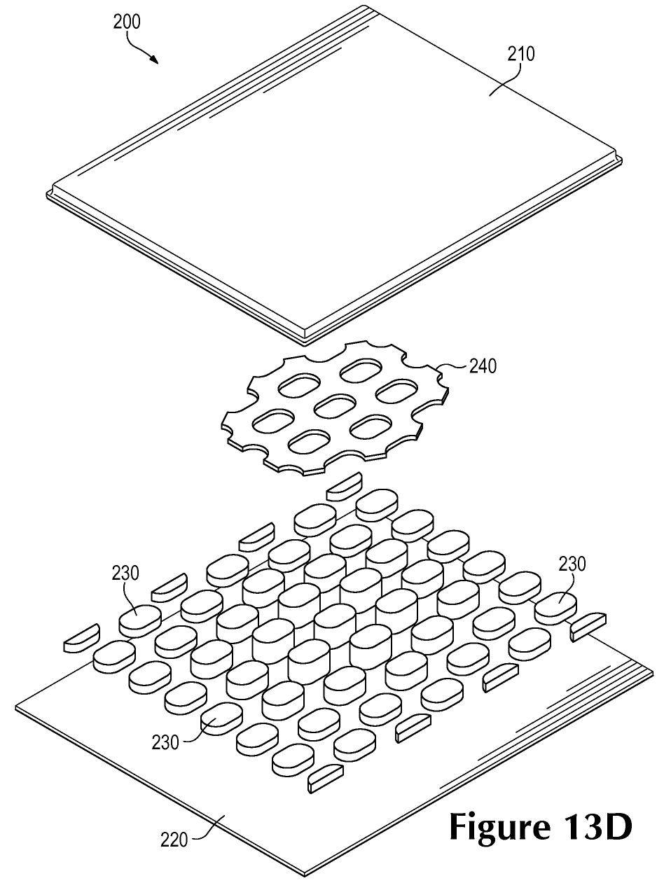

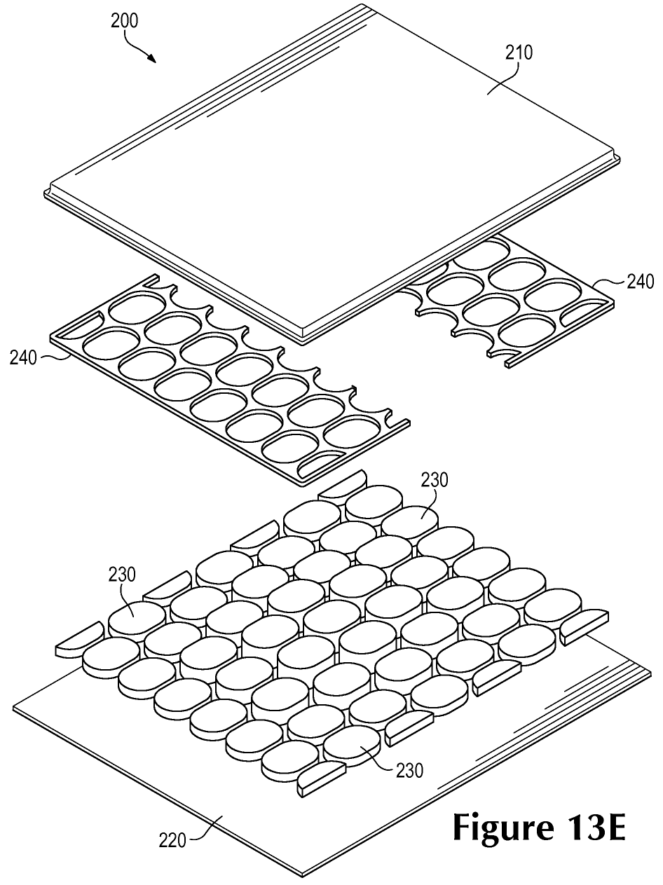

A further configuration of cushioning element 200 is depicted in FIG. 13A, wherein frame component 240 extends around and between each of pad components 230. That is, frame component 240 extends to peripheral areas of cushioning element 200 and defines apertures 244 that receive each of pad components 230. In another configuration, as depicted in FIG. 13B, frame component 240 is located in the peripheral areas of cushioning element 200 and is absent from the central area of cushioning element 200. Frame component may also be absent from cushioning element 200, as depicted in FIG. 13C. Depending upon the spacing of pad components 230, the dimensions of frame component 240 and the spacing between apertures 244 may vary. Referring to FIG. 13D, pad components 230 exhibit greater spacing and the spacing between apertures 244 is varied accordingly. Although one frame component 240 may be utilized in cushioning element 200, multiple frame components 240 may be utilized in some configurations. Referring to FIG. 13E, two separate and spaced frame components 240 are located at opposite ends of cushioning element 200.

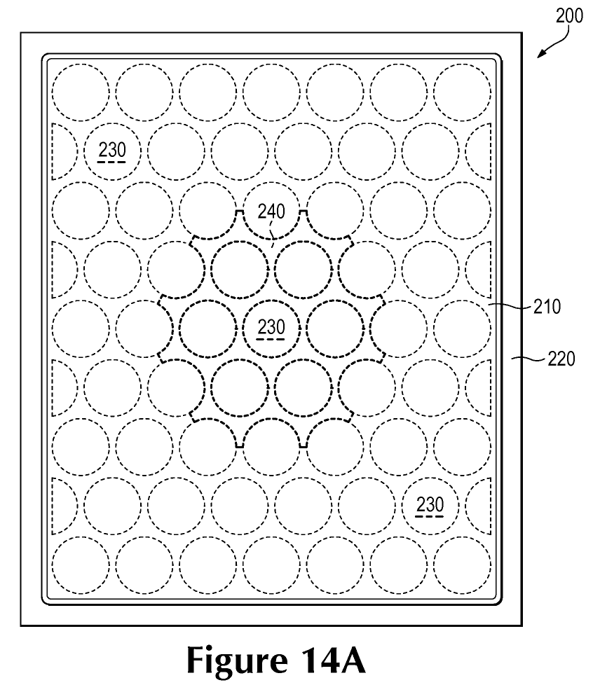

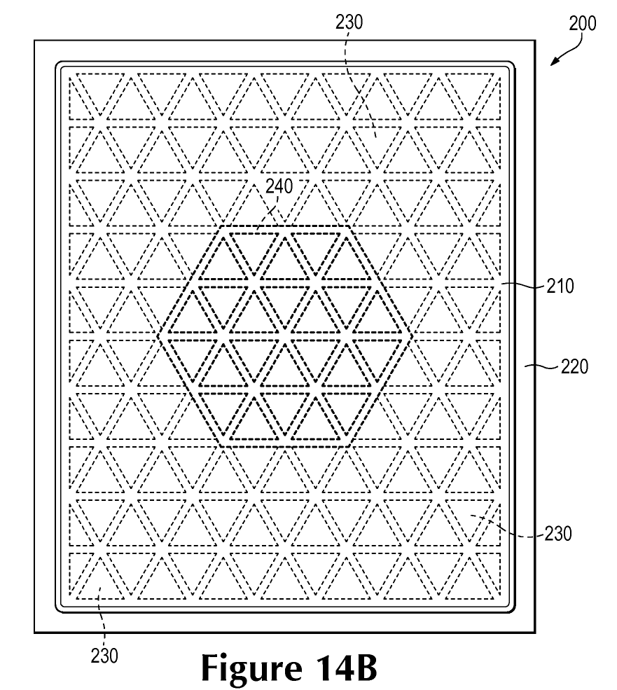

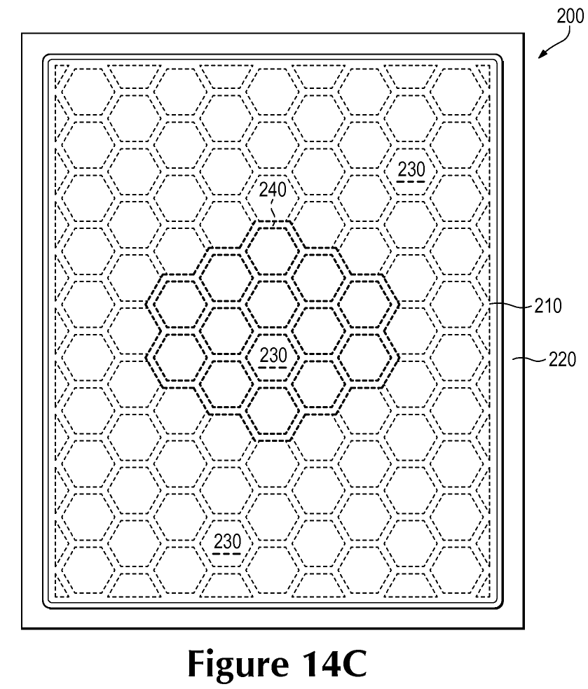

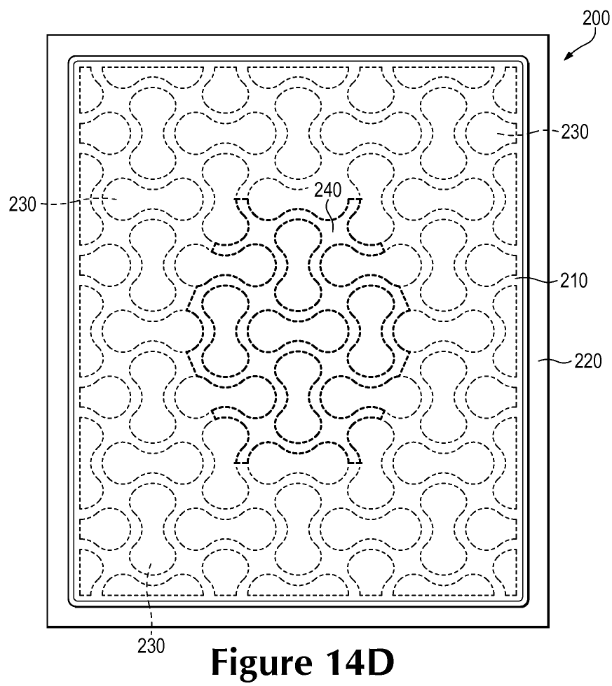

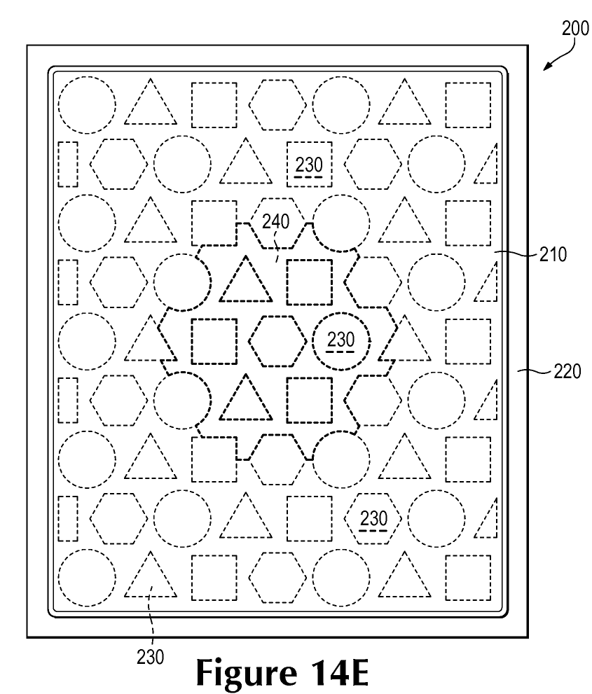

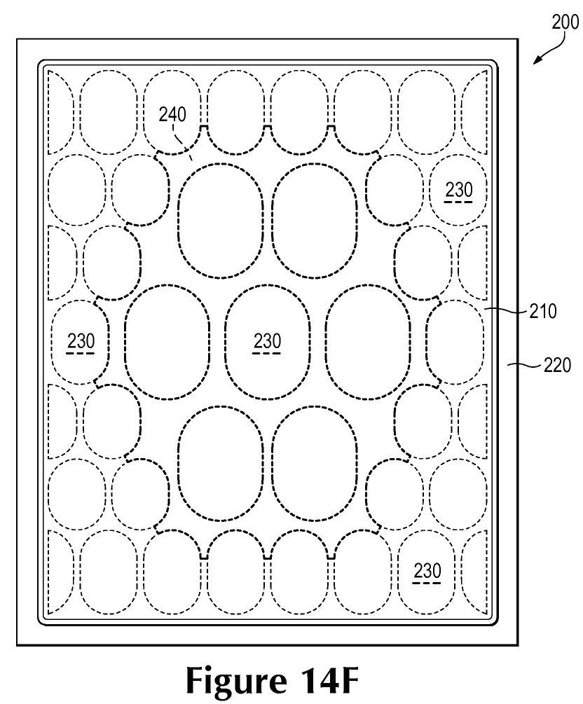

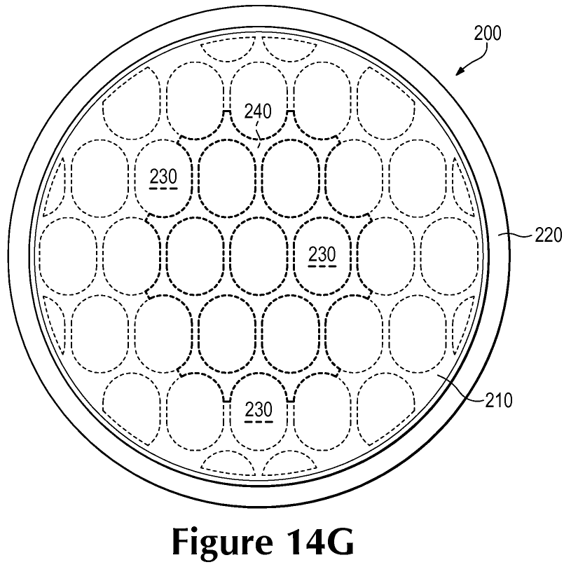

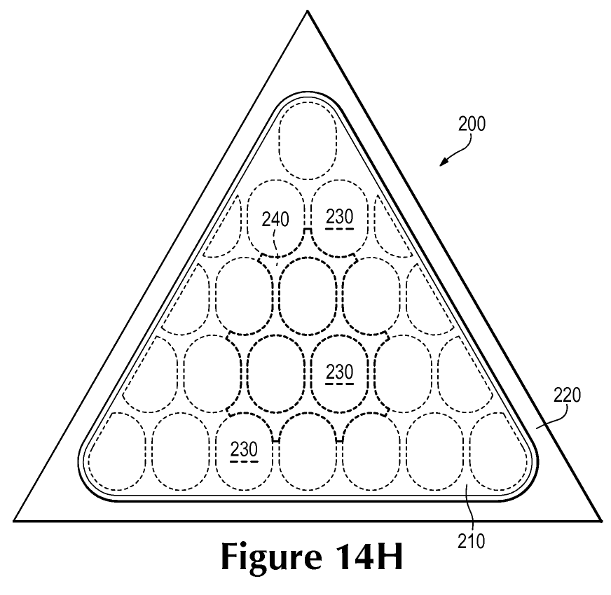

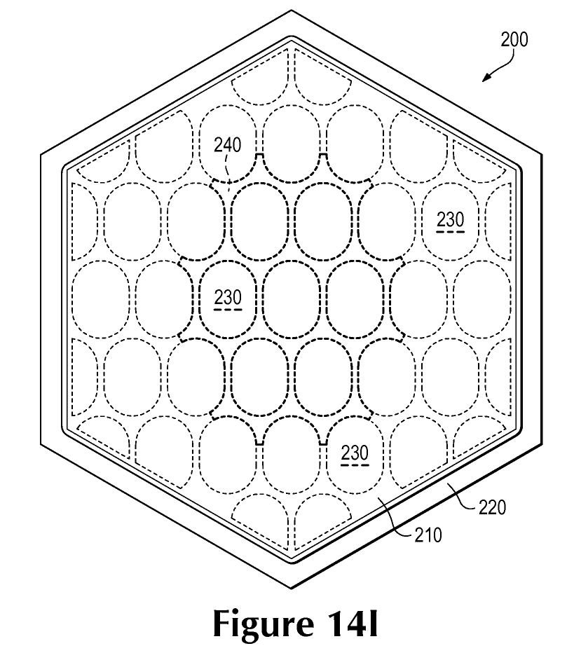

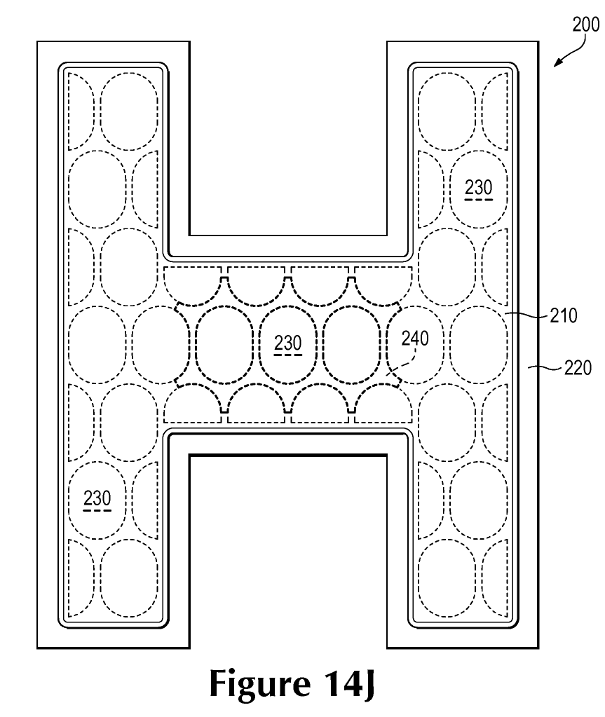

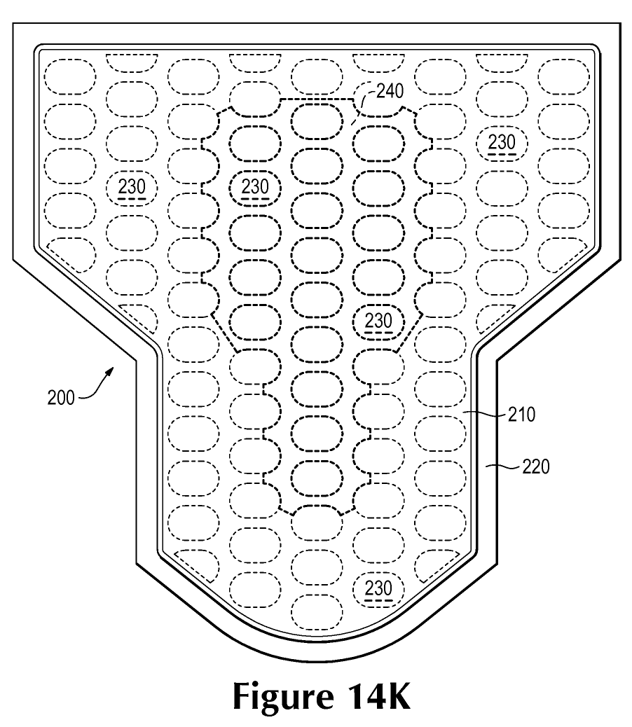

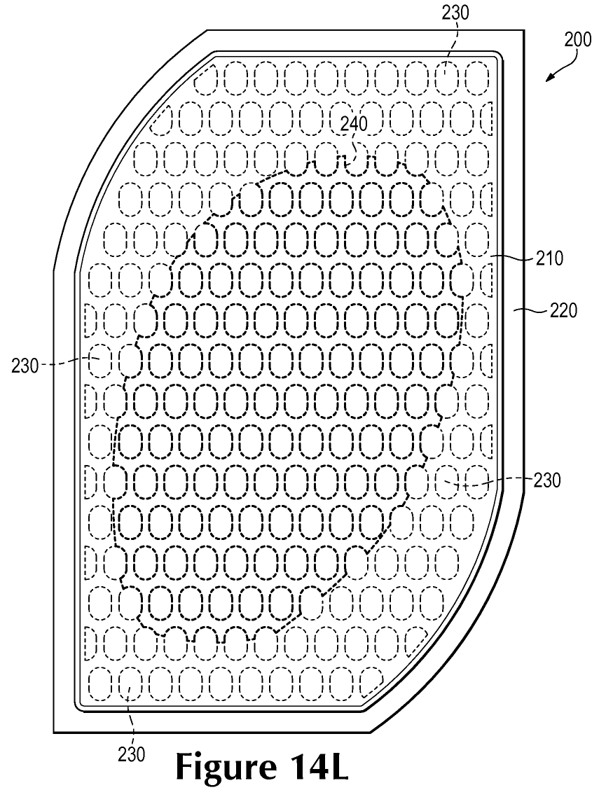

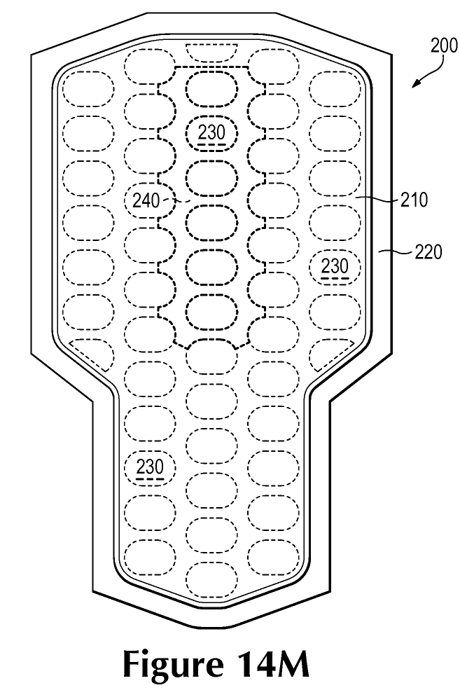

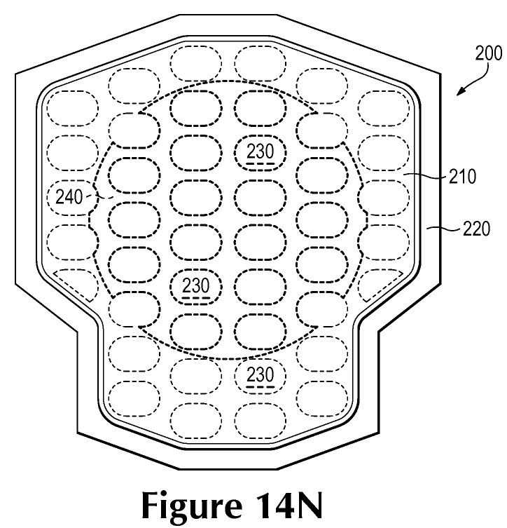

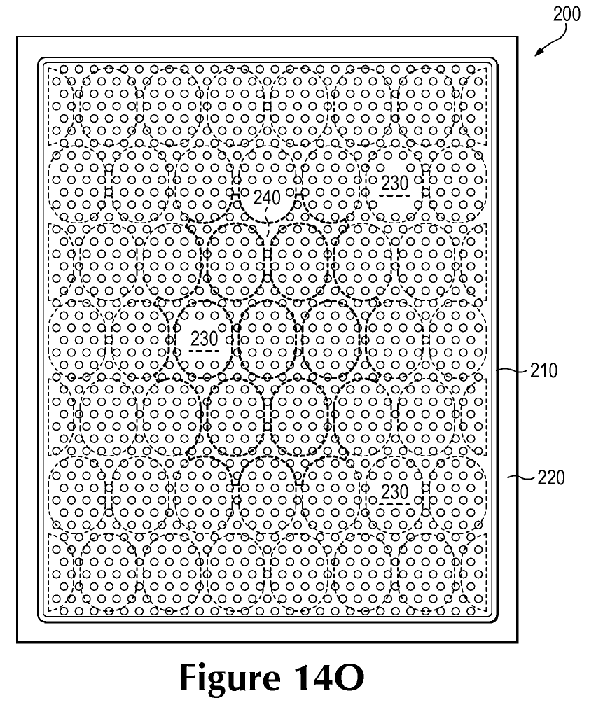

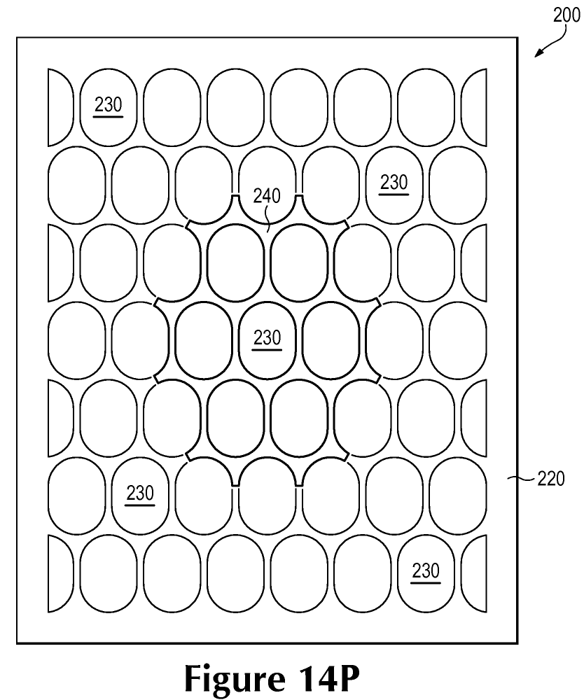

Pad components 230 are discussed above as having an elliptical or generally elongate shape with rounded end areas. Pad components 230 may, however, have a variety of other shapes, including round, triangular, and hexagonal, as respectively depicted in FIGS. 14A-14C. Pad components 230 may have an irregular shape, as depicted in FIG. 14D, or may be a mixture of different shapes, as depicted in FIG. 14E. Although each of pad components 230 may have the same shape and size, pad components 230 may also have generally similar shapes with a variety of different sizes, as depicted in FIG. 14F.

In addition to aspects of pad components 230 and frame component 240 that may vary significantly, the overall shape of cushioning element 200 may vary. Referring to FIG. 14G, cushioning element 200 exhibits a generally circular shape. In further configurations, cushioning element 200 may have a triangular, hexagonal, or H-shaped structure, as respectively depicted in FIGS. 14H-14J. Various shapes for cushioning element 200 are also depicted in association with apparel 100 in FIGS. 1-5. As examples of these, one of cushioning elements 200 from apparel 100 that has a shape suitable for a hip pad is depicted in FIG. 14K, one of cushioning elements 200 from apparel 100 that has a shape suitable for a thigh pad is depicted in FIG. 14L, and one of cushioning elements 200 from apparel 100 that has a shape suitable for a tailbone pad is depicted in FIG. 14M. A configuration for cushioning element 200 that has a shape suitable for an elbow pad (e.g., for a shirt, jacket, or arm sleeve) is depicted in FIG. 14N.

Various aspects relating to first material layer 210 and second material layer 220 may also vary significantly. As discussed above, material layers 210 and 220 may be formed from various textiles, polymer sheets, leather, synthetic leather, or combinations of materials, for example. Referring to FIG. 14O, first material layer 210 is depicted as having the configuration of a mesh material that defines a plurality of holes, through which pad components 230 and frame component 240 are visible. In addition to imparting greater breathability that allows the transfer of air and moisture, a mesh material may allow for various aesthetic properties. More particularly, pad components 230 and frame component 240 may have different colors that are visible through first material layer 210, or pad components 230 with different thicknesses may have different colors to assist with identifying the internal configuration of cushioning element 200. In addition to a mesh material, other at least semi-transparent textile or polymer sheet materials may also permit pad components 230 with different colors to be visible. In further configurations, first material layer 210 may be entirely absent from cushioning element 200, as depicted in FIG. 14P.

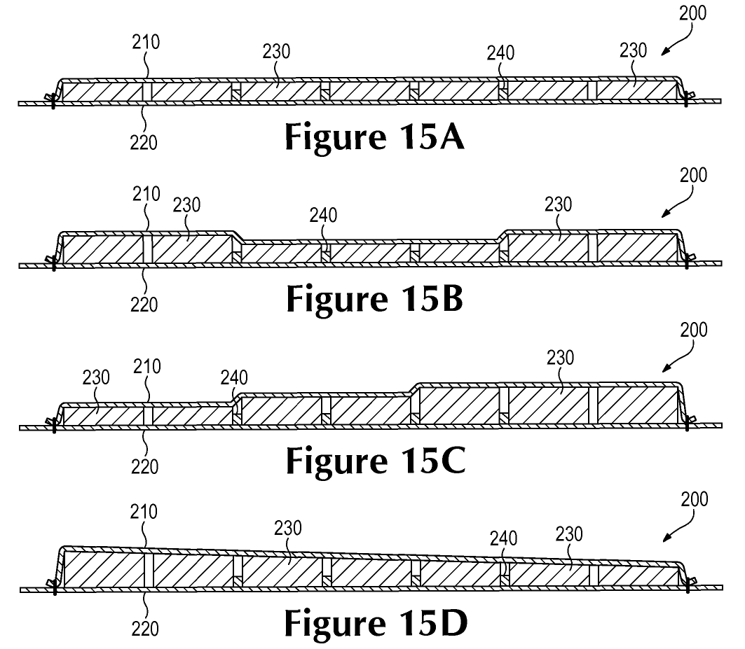

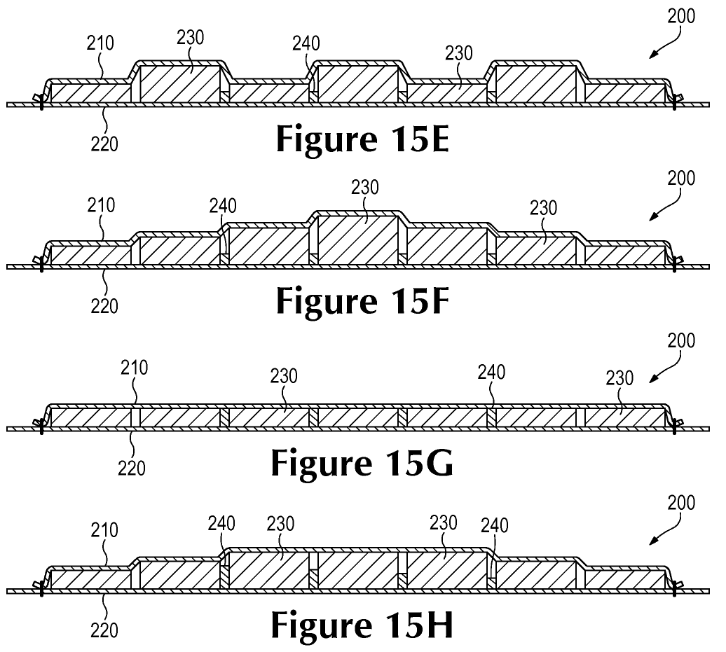

Although the thicknesses of pad components 230 may vary in the manner discussed above, pad components 230 may also have substantially identical thicknesses, as depicted in FIG. 15A. In some configurations of cushioning element 200, pad components 230 located in the central area may have lesser thickness than pad components 230 located in the peripheral area, as depicted in FIG. 15B. The thicknesses of pad components 230 may also decrease across the width of cushioning element 200, as depicted in FIG. 15C, or may taper across the width of cushioning element 200, as depicted in FIG. 15D. Referring to FIG. 15E, the thicknesses of pad components 230 may also alternate. Although pad components 230 may have a common thickness, two different thicknesses, or three thicknesses, the number of thicknesses may vary significantly. As an example, a configuration wherein pad components 230 exhibit four thicknesses is depicted in FIG. 15F.

In each of the configurations discussed above, frame component 240 exhibits lesser thickness than each of pad components 230. Referring to FIG. 15G, frame component 240 exhibits a thickness that is substantially equal to the thicknesses of pad components 230, but the thickness of frame component 240 may also be greater than the thickness of pad components 230 in some configurations. Another example is depicted in FIG. 15H, wherein the thickness of frame component 240 varies across the width of cushioning element 200.

Further Apparel and Product Configurations

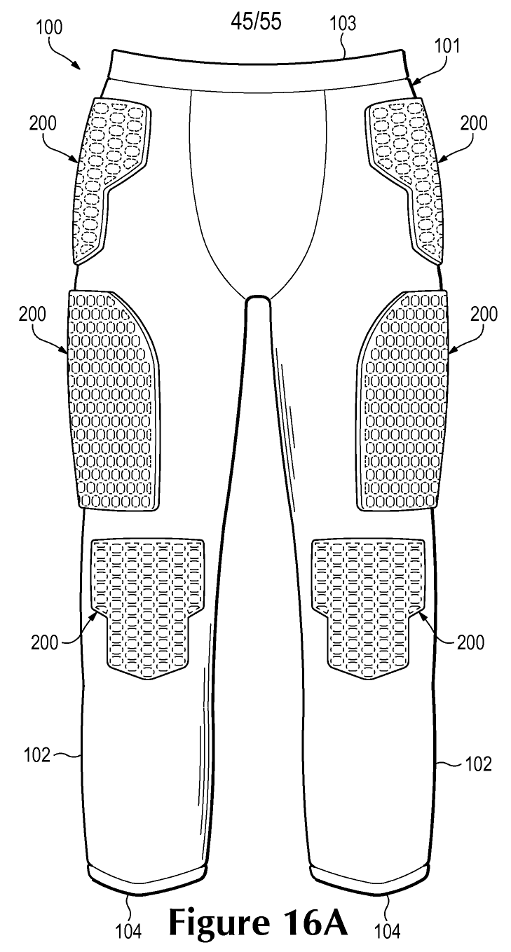

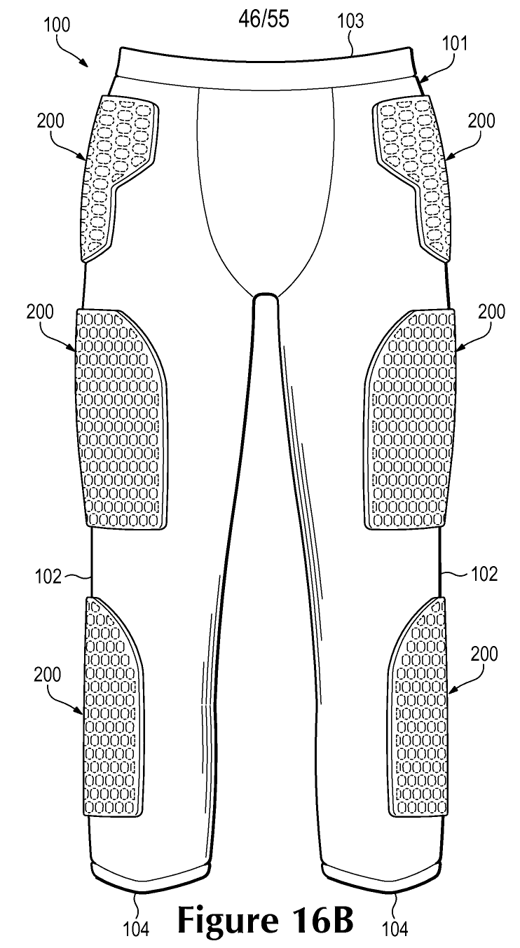

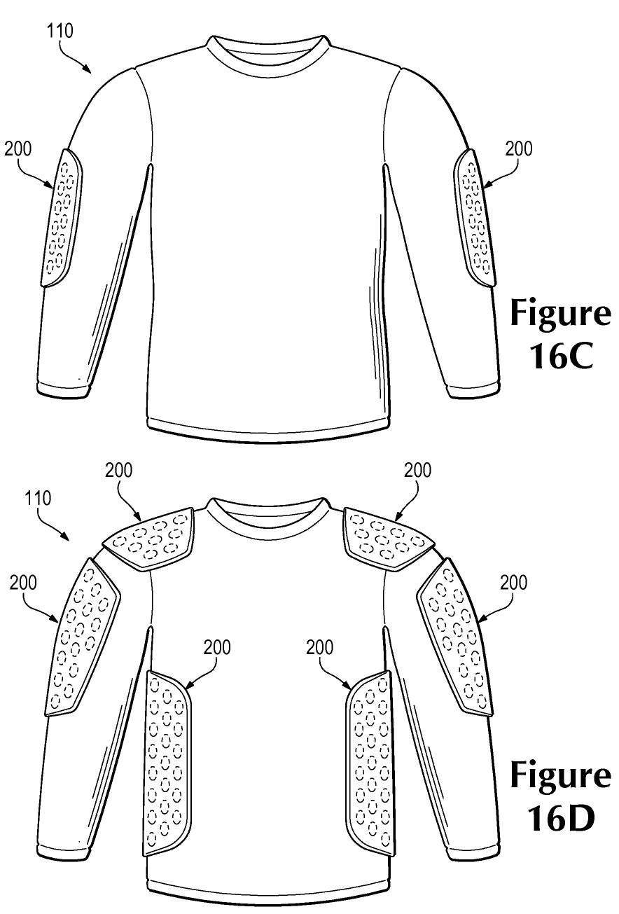

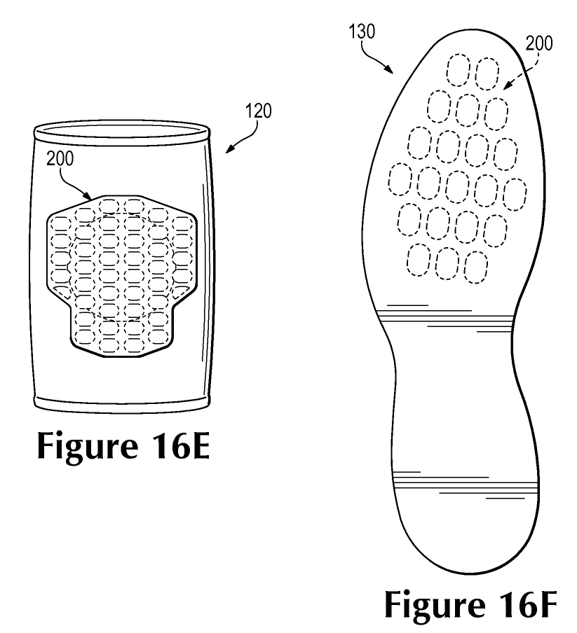

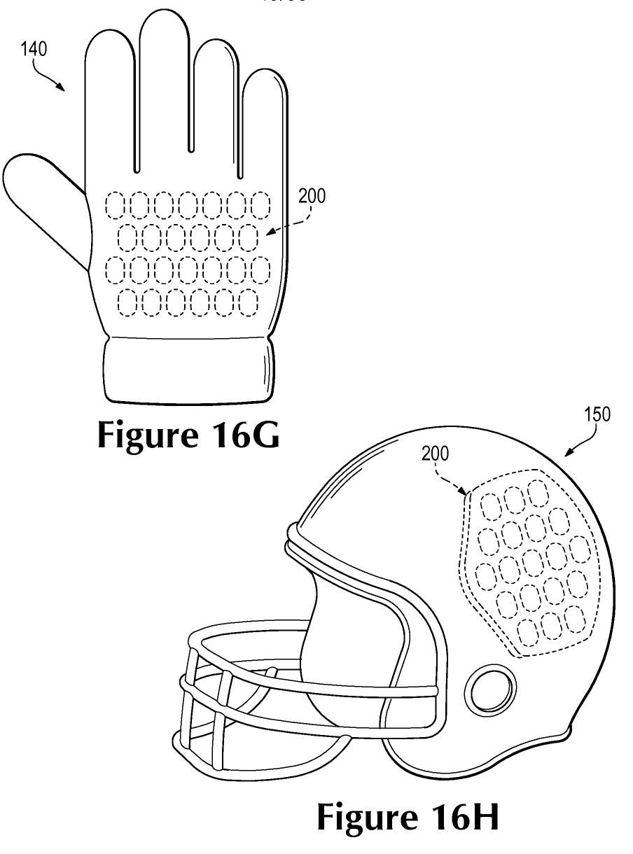

Apparel 100 is depicted in FIGS. 1-5 as having the general configuration of a shorts-type garment. Referring to FIG. 16A, leg regions 102 of apparel 100 extend downward to a greater degree, thereby imparting the configuration of a pants-type garment that includes additional cushioning elements 200 for the knees of individual 10. A similar configuration is depicted in FIG. 16B, wherein apparel 100 includes additional cushioning elements 200 for the ankles or lower legs of individual 10.

In addition to shorts-type garments and pants-type garments, a variety of other types of apparel may also incorporate cushioning elements 200 in any of the configurations discussed above. Referring to FIG. 16C, an article of apparel 110 having the configuration of a shirt-type garment is depicted as including two cushioning elements 200 in locations that correspond with elbows of a wearer. When worn, cushioning elements 200 may provide protection to the elbows. That is, cushioning elements 200 may attenuate impact forces upon the elbows. In addition to attenuating impact forces, cushioning elements 200 may also simultaneously provide one or more of breathability, flexibility, a relatively low overall mass, and launderability. Although apparel 110 is depicted as a long-sleeved shirt, apparel 110 may have the configuration of other shirt-type garments, including short-sleeved shirts, tank tops, undershirts, jackets, and coats, for example. Referring to FIG. 16D, apparel 110 is depicted as including six cushioning elements 200 in locations that correspond with elbows, shoulders, and sides of a wearer.

Cushioning elements 200 may also be incorporated into apparel that covers other areas of the wearer, such as hats, helmets, wraps, footwear, socks, and gloves, for example. As an example, a wrap 120 with one cushioning element 200 is depicted in FIG. 16E. Wrap 120 has a generally cylindrical configuration that may be placed upon an arm or a leg of a wearer. When, for example, the elbow is sore or injured, cushioning element 200 of wrap 120 may be located over the elbow to assist with protecting the elbow during athletic activities. As another example, a sockliner 130 that incorporates a cushioning element 200 is depicted in FIG. 16F. Sockliner 130 may be located within an article of footwear to cushion a lower (i.e., plantar) surface of the foot. Additionally, one or more cushioning elements 200 may be incorporated into a glove 140, as depicted in FIG. 16G, to impart protection to a hand of the wearer. One or more cushioning elements 200 may also be incorporated into a helmet 150, as depicted in FIG. 16H, to impart protection to a head of the wearer. In addition to attenuating impact forces, cushioning elements 200 in these configurations may also simultaneously provide one or more of breathability, flexibility, a relatively low overall mass, and launderability.

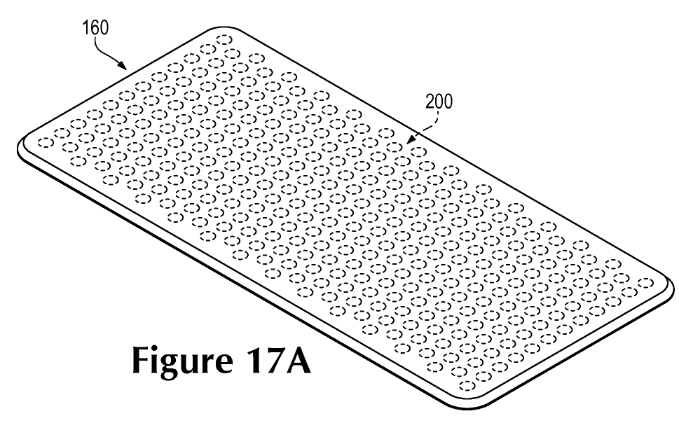

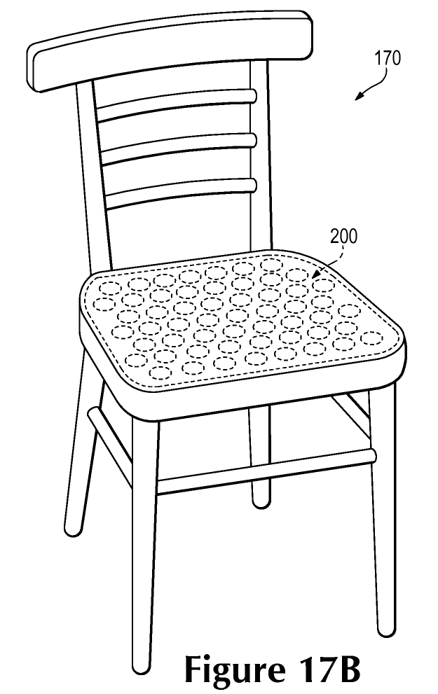

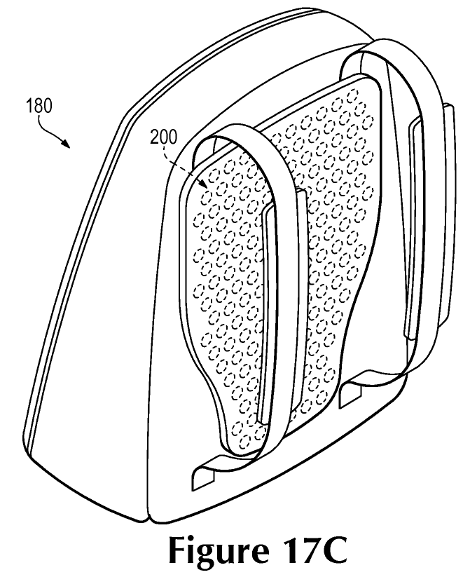

Cushioning elements 200 may also be utilized in products other than apparel. Referring to FIG. 17A, a mat 160 is depicted as being primarily formed from one cushioning element 200. Mat 160 may be utilized, for example, during yoga or as a camping pad to provide a comfortable surface for sitting or laying on the ground. A cushioning element 200 may also be incorporated into a chair 170, as depicted in FIG. 17B, to provide a comfortable place to sit. Similarly, a cushioning element 200 may be incorporated into a cushion that may be placed upon a chair or upon bleachers at a sporting event, for example. Also, a cushioning element 200 may be incorporated into a backpack 180, as depicted in FIG. 17C, to provide cushioning against the back of the wearer. Accordingly, various configurations of cushioning elements 200 may be incorporated into a plurality of products.

Another Cushioning Element Configuration

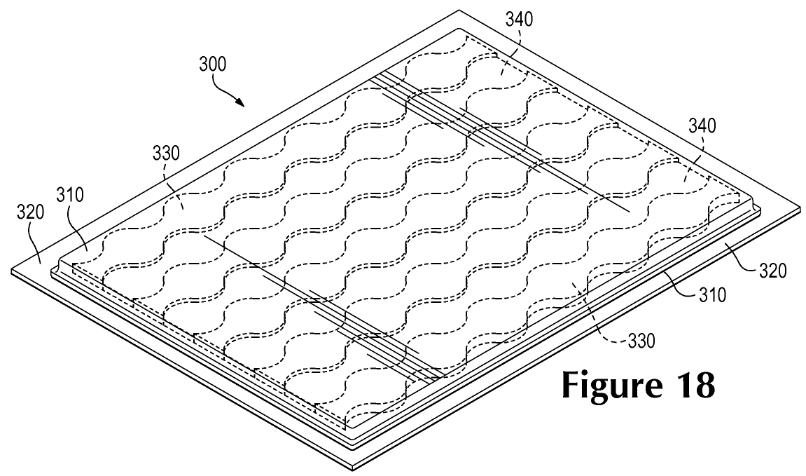

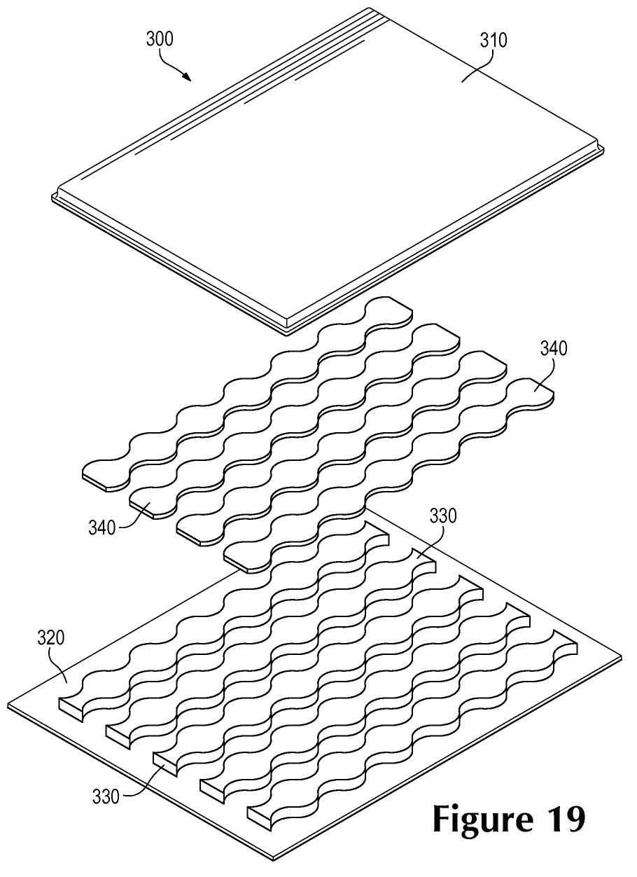

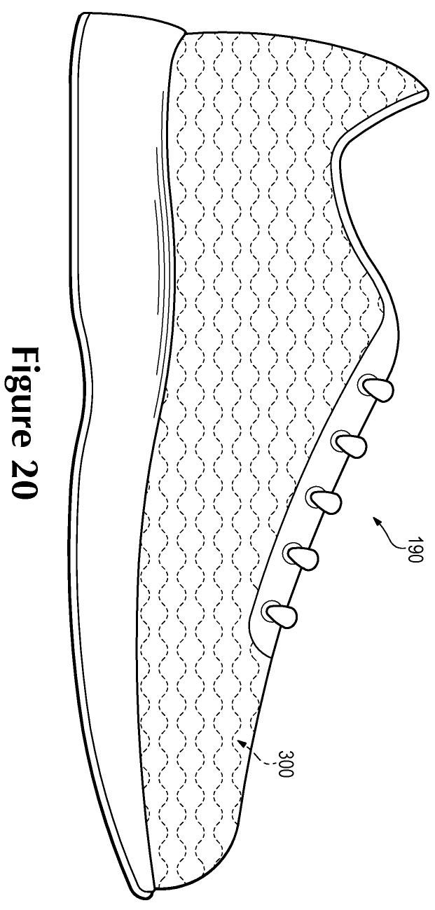

An example configuration for a cushioning element 300 is depicted in FIGS. 18 and 19 as including a first material layer 310, a second material layer 320, a plurality of first strips 330, and a plurality of second strips 340. In addition to attenuating impact forces, cushioning element 300 has an advantage of simultaneously providing one or more of breathability, flexibility, a relatively low overall mass, and launderability.

First material layer 310 and second material layer 320 cooperatively form an outer surface or covering for cushioning element 300. In general, strips 330 and 340 are positioned between first material layer 310 and second material layer 320. Although first strips 330 are secured to each of first material layer 310 and second material layer 320, second strips 340 are unsecured to each of first material layer 310, second material layer 320, and first strips 330. Any of the various materials discussed above for material layers 210 and 220 may also be utilized for material layers 310 and 320.

First strips 330 are located between and secured to each of material layers 310 and 320. Moreover, each of first strips 330 are arranged in a generally spaced and parallel relationship, and edges of first strips 330 exhibit a wavy or undulating configuration. Second strips 340 are also located between each of material layers 310 and 320. In contrast with first strips 330, second strips 330 are unsecured to each of material layers 310 and 320, and second strips 340 are also unsecured to first strips 330. This configuration permits second strips 340 to float or otherwise move relative to first material layer 310, second material layer 320, and second strips 330. As with first strips 330, second strips 340 exhibit a wavy or undulating configuration. The corresponding wavy or undulating configurations in strips 330 and 340 effectively prevent longitudinal or sliding movement of second strips 340. That is, strips 340 may be able to move toward and away from material layers 310 and 320, but may be prevented from sliding relative to material layers 310 and 320 due to the corresponding wavy or undulating configurations in strips 330 and 340. Although the corresponding wavy or undulating edges in strips 330 and 340 effectively prevent longitudinal or sliding movement of second strips 340, a variety of other configurations may be utilized, including T-shaped cutouts in one of strips 330 and 340 that receive T-shaped protrusions from the other of strips 330 and 340.

Any of the variety of materials discussed above for pad components 230 and frame component 240 may be utilized for strips 330 and 340, including various polymer foam materials that return to an original shape after being compressed. Examples of suitable polymer foam materials for strips 330 and 340 include polyurethane, ethylvinylacetate, polyester, polypropylene, and polyethylene foams. Moreover, both thermoplastic and thermoset polymer foam materials may be utilized. Polymer sheet materials or combinations of various materials may also be utilized for strips 330 and 340.

Referring to FIG. 19, for example, second strips 340 are depicted as exhibiting lesser thicknesses than each of first strips 330. As an example, first strips 330 may have a thickness of approximately 4 millimeters, whereas second strips may have a thickness of approximately 2 millimeters. The thicknesses of strips 330 and 340 may, however, range from 1 to 20 millimeters or more. Although second strips 340 may exhibit lesser thickness than each of first strips 330, second strips 340 may also be thicker in some configurations.

In addition to thickness, the relative density between first strips 330 and second strips 340 may vary. For example, first strips 330 may be formed from a material with lesser density than second strips 340. More particularly, first strips 330 may be formed from a lighter and more compressible polymer foam material than second strips 340. Alternately, second strips 340 may be formed from a material with lesser density than first strips 330.

Although strips 330 and 340 may be molded or die-cut, a laser-cutting operation may also be utilized to impart precise tolerances between strips 330 and 340. In some configurations, end areas of first strips 330, for example, may be connected. That is, a single material element forming first strips 330 may be formed to ensure that first strips 330 remain properly positioned relative to each other, and the material element may define apertures (i.e. areas between first strips 330) that receive second strips 340.

An advantage of cushioning element 300 relates to moldability. When at least some of first material layer 310, second material layer 320, first strips 330, and second strips 340 incorporate a thermoplastic polymer material, cushioning element 300 may be heated, molded to a desired shape, and allowed to cool in order to retain that shape. Referring to FIG. 20, cushioning element 300 is depicted as being incorporated into an upper portion of an article of footwear 190, which is utilized to comfortably and securely receive a foot of a wearer. Given that the upper portion of footwear 190 has a shape that extends over instep and toe areas of the foot, along medial and lateral sides of the foot, around a heel area of the foot, and under the foot, cushioning element 300 effectively has a three-dimensional shape. By heating, molding, and cooling cushioning element 300 (or multiple joined cushioning elements 300), cushioning element 300 may form a three-dimensional structure that extends around the foot. Moreover, cushioning element 300 may impart one or more of impact force attenuation, breathability, flexibility, a relatively low overall mass, and launderability to footwear 190. In addition to footwear 190, cushioning element 300 may be incorporated into various other articles of apparel (e.g., shorts, pants, shirts, wraps, gloves, and helmets) and products (e.g., mats, chairs, and backpacks).

The invention is disclosed above and in the accompanying figures with reference to a variety of configurations. The purpose served by the disclosure, however, is to provide an example of the various features and concepts related to the invention, not to limit the scope of the invention. One skilled in the relevant art will recognize that numerous variations and modifications may be made to the configurations described above without departing from the scope of the present invention, as defined by the appended claims.

1. A cushioning element comprising:
a first material layer and a second material layer;
a plurality of pad components located between the first material layer and the second material layer, the pad components being secured to the first material layer and the second material layer; and
a frame component located between the first material layer and the second material layer, the frame component defining a plurality of apertures that receive at least a portion of the pad components, and the frame component being unsecured to the first material layer, the second material layer, and the pad components.

2. The cushioning element recited in claim 1, wherein all of the pad components are positioned within the apertures.

3. The cushioning element recited in claim 1, wherein only a portion of the pad components are positioned within the apertures.

4. The cushioning element recited in claim 1, wherein the frame component is located in a central area of the cushioning element and absent from a peripheral area of the cushioning element.

5. The cushioning element recited in claim 1, wherein thicknesses of the pad components are greater than a thickness of the frame component.

6. The cushioning element recited in claim 1, wherein the pad components and the frame component are formed from polymer foam materials.

7. The cushioning element recited in claim 1, wherein the first material layer and the second material layer are textile materials.

8. The cushioning element recited in claim 1, wherein the first material layer is joined to the second material layer around a periphery of the pad components.

9. An article of apparel comprising:
a first material layer and a second material layer; and
a plurality of foam components located between the first material layer and the second material layer, a majority of the foam components being secured to both of the first material layer and the second material layer, and at least one of the foam components being unsecured to both of the first material layer and the second material layer, the foam components having corresponding shapes that mate with each other to form a foam layer within the apparel.

10. The article of apparel recited in claim 9, wherein the foam components include a frame that defines a plurality of apertures, and the foam components include a plurality of pads located within the apertures.

11. The article of apparel recited in claim 10, wherein all of the pads are positioned within the apertures.

12. The article of apparel recited in claim 10, wherein only a portion of the pads components are positioned within the apertures.

13. The article of apparel recited in claim 10, wherein thicknesses of the pads are greater than a thickness of the frame.

14. The article of apparel recited in claim 10, wherein the pads are unsecured to the frame.

15. An article of apparel comprising:
a first textile layer that defines at least a portion of an interior surface of the apparel and at least a portion of an opposite exterior surface of the apparel; and
at least two second textile layers, each of the second textile layers being joined to different areas of the first textile layer, and each of the second textile layers forming pockets with the first textile layer, each of the pockets including (a) a plurality of pad components joined to at least the first textile layer and (b) a frame component defining a plurality of apertures that receive the pad components.

16. The article of apparel recited in claim 15, wherein the frame component is unsecured to the textile layers and the pad components.

17. The article of apparel recited in claim 15, wherein the pad components and the frame component are formed from polymer foam materials.

18. The article of apparel recited in claim 15, wherein thicknesses of the pad components are greater than a thickness of the frame component in at least one of the pockets.

19. A cushioning element comprising:
a first material layer and a second material layer;
a plurality of first strips located between the first material layer and the second material layer, the first strips being secured to the first material layer and the second material layer, and the first strips being spaced from each other; and
a plurality of second strips located between the first material layer and the second material layer, the second strips being unsecured to the first material layer and the second material layer, and the first strips being positioned between the first strips,
wherein (a) at least one of the first strips and the second strips are molded to impart a non-planar configuration to the cushioning element, (b) each of the first strips and the second strips have edges with an undulating configuration that mate with each other, and (c) a thickness of the first strips is greater than a thickness of the second strips.

20. The cushioning element recited in claim 19, wherein the first strips are formed from a polymer foam material, and the second strips are formed from a material with greater density than the polymer foam material.
